(19) United States
(12) Patent Application Publication
(10) Pub. No.: US 2025/0258891 A1
(43) Pub. Date: Aug. 14, 2025

(54) SENSOR APPARATUS, CONTROL METHOD, INFORMATION PROCESSING APPARATUS, AND INFORMATION PROCESSING SYSTEM

(71) Applicant: Sony Semiconductor Solutions Corporation, Kanagawa (JP)

(72) Inventors: Munetake EBIHARA, Kanagawa (JP); Tomokazu HIBINO, Kanagawa (JP); Ryoji EKI, Kanagawa (JP); Hiroyuki OKUMURA, Kanagawa (JP)

(73) Assignee: Sony Semiconductor Solutions Corporation, Kanagawa (JP)

(21) Appl. No.: 18/850,071

(22) PCT Filed: Feb. 17, 2023
(86) PCT No.: PCT/JP2023/005753

§ 371 Date: Sep. 24, 2024

(30) Foreign Application Priority Data
Apr. 6, 2022 (JP) 2022-063265

(51) Int. Cl. G06F 21/10; H04L 9/08; H04L 9/32

(52) U.S. Cl. CPC G06F 21/107; H04L 9/0819; H04L 9/3271

(57) ABSTRACT

It is attempted to prevent undesirable fraudulent use of AI models by fraudulent acts or the like when the AI models are used in a subscription-service-like manner for image-capturing apparatuses having AI functions.

A sensor apparatus according to the present technology includes an image-capturing section that captures an image of a subject, an AI processing section that performs AI processing which is a process using an AI model on an image captured by the image-capturing section, and a control section that receives, from an external apparatus, license data representing a use upper limit condition related to the AI model and performs execution control of the AI processing performed by the AI processing section, such that the use upper limit condition is satisfied.

### TECHNICAL FIELD

The present technology relates to a sensor apparatus having a function to perform AI (Artificial Intelligence) processing which is a process using an AI model on captured images obtained by capturing images of subjects, a control method to be performed in such a sensor apparatus, an information processing apparatus that performs processes related to the sensor apparatus, and an information processing system including the sensor apparatus and the information processing apparatus.

### BACKGROUND ART

There may be a solution business using an image-capturing apparatus (hereinafter, expressed as an “AI camera”) that performs AI processing which is a process using AI (Artificial Intelligence) model on captured images. For example, there may be a business that provides a system in which one or multiple AI cameras are arranged in a store, recognition results regarding attributes (e.g., genders, age brackets, etc.) or behavioral patterns of customers are obtained by, for example, an image recognition process, and the recognition results are presented to users via the Internet or the like, for example.

Since AI processing is performed on the side of AI cameras, it is possible to attempt to distribute processes and also attempt to reduce communication data amounts, as compared with a system in which AI processing is performed on the side of a server apparatus on the basis of captured images acquired from respective cameras.

Note that examples of related conventional technologies include PTL 1 described below. PTL 1 described below discloses a technology to distribute AI models from a server apparatus to AI cameras.

### CITATION LIST

### Patent Literature

### [PTL 1]

PCT Patent Publication No. WO2020/100922

### SUMMARY

### Technical Problem

Here, in the solution business using AI cameras as described above, it is possible that, for example, AI models are used in a subscription-service-like manner as in an online rental video service or the like. For example, an AI model is permitted to be used in an AI camera according to a contract that specifies a use period such as a one-month period.

In a case where a service to allow use of an AI model in a subscription-service-like manner as described above is examined, it should be attempted to prevent fraudulent use in which, by fraudulent acts, for example, someone other than a contractor is undesirably allowed to use an AI model, the contractor is undesirably allowed to use the AI model even after a use period, and so on.

The present technology has been made in view of the circumstances described above, and an object thereof is to attempt to prevent undesirable fraudulent use of AI models by fraudulent acts or the like when the AI models are used in a subscription-service-like manner for image-capturing apparatuses having AI functions.

### Solution to Problem

A sensor apparatus according to the present technology includes an image-capturing section that captures an image of a subject, an AI processing section that performs AI processing which is a process using an AI model on an image captured by the image-capturing section, and a control section that receives, from an external apparatus, license data representing a use upper limit condition related to the AI model and performs execution control of the AI processing performed by the AI processing section, such that the use upper limit condition is satisfied.

According to the configuration described above, the AI processing section is provided in the sensor apparatus having the image-capturing section. Further, according to the configuration described above, in a case where the AI model is to be used in a subscription-service-like manner for an image-capturing apparatus having an AI function, for example, the execution control of AI processing for satisfying the use upper limit condition such as a use deadline is performed in the sensor apparatus. Since the execution control of AI processing for satisfying the use upper limit condition is performed in the sensor apparatus in such a manner, it becomes possible to make it difficult for the use upper limit condition to be operated fraudulently, even if there is an attack on a communication path between the sensor apparatus and a processor provided outside the sensor apparatus in the image-capturing apparatus.

In addition, a control method according to the present technology is a control method to be performed in a sensor apparatus including an image-capturing section that captures an image of a subject and an AI processing section that performs AI processing which is a process using an AI model on an image captured by the image-capturing section, the control method including receiving, from an external apparatus, license data representing a use upper limit condition related to the AI model and performing execution control of the AI processing performed by the AI processing section, such that the use upper limit condition is satisfied.

Also with such a control method, effects similar to those achieved with the sensor apparatus according to the present technology described above can be achieved.

An information processing apparatus according to the present technology includes a transmitting section that transmits license data representing a use upper limit condition related to an AI model to a sensor apparatus including an image-capturing section that captures an image of a subject, an AI processing section that performs AI processing which is a process using the AI model on an image captured by the image-capturing section, and a control section that performs, on the basis of the license data, execution control of the AI processing performed by the AI processing section, such that the use upper limit condition is satisfied.

With such an information processing apparatus, the AI model use condition for the sensor apparatus can be specified.

An information processing system according to the present technology includes a sensor apparatus having an image-capturing section that captures an image of a subject, an AI processing section that performs AI processing which is a process using an AI model on an image captured by the image-capturing section, and a control section that performs, on the basis of license data representing a use upper limit condition related to the AI model, execution control of the AI processing performed by the AI processing section, such that the use upper limit condition is satisfied, and an information processing apparatus having a transmitting section that transmits the license data to the sensor apparatus.

With such an information processing system, it becomes possible to attempt to prevent the AI model from being fraudulently used undesirably in an image-capturing apparatus having an AI function.

### BRIEF DESCRIPTION OF DRAWINGS

FIG. 1 is a block diagram depicting a schematic configuration example of an information processing system as an embodiment.

FIG. 2 is a block diagram depicting a hardware configuration example of an information processing apparatus included in the information processing system as an embodiment.

FIG. 3 is a block diagram depicting a configuration example of an image-capturing apparatus including a sensor apparatus as an embodiment.

FIG. 4 is a diagram for explaining a structural example of the sensor apparatus as an embodiment.

FIG. 5 is a functional block diagram for explaining functions as an embodiment that the information processing apparatus (server apparatus) in an embodiment has.

FIG. 6 is a figure depicting a structural example of license data in an embodiment.

FIG. 7 is a functional block diagram for explaining functions as an embodiment that the sensor apparatus according to an embodiment has.

FIG. 8 is a flowchart of processes related to user account registration in the information processing system as an embodiment.

FIG. 9 is a flowchart of processes ranging from an AI model purchase to AI model deployment in the information processing system as an embodiment.

FIG. 10 is a flowchart depicting processes that should be performed in the information processing system for AI processing execution management based on a license contract period.

FIG. 11 is a flowchart depicting processes related to license data transmission and challenge response authentication in an embodiment.

### DESCRIPTION OF EMBODIMENT

Hereinbelow, an embodiment according to the present technology is explained in the following order with reference to the attached figures.
<1. Information Processing System>
(1-1. Overall System Configuration)
(1-2. Configuration of Information Processing Apparatus) (1-3. Configuration of Image-Capturing Apparatus)
<2. Functions as Embodiment>
<3. Processing Procedure>
<4. Modification Examples>
<5. Summary of Embodiment>
<6. Present Technology>

### 1. Information Processing System

### (1-1. Overall System Configuration)

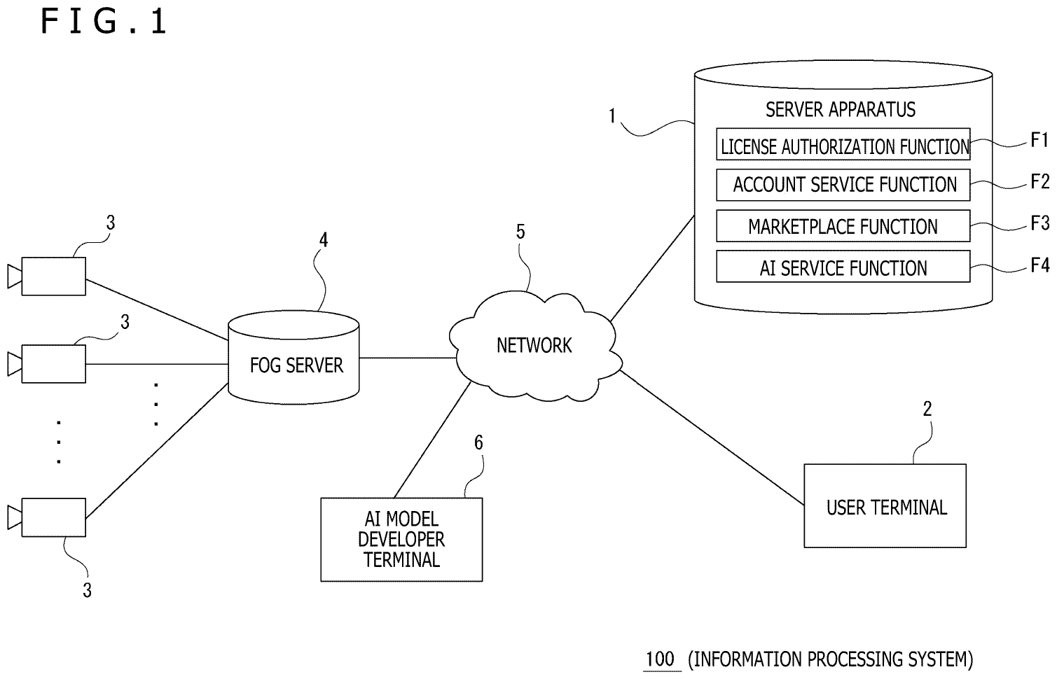

FIG. 1 is a block diagram depicting a schematic configuration example of an information processing system 100 as an embodiment according to the present technology.

As depicted in the figure, the information processing system 100 includes a server apparatus 1, one or multiple user terminals 2, multiple cameras 3, a fog server 4, and an AI (Artificial Intelligence) model developer terminal 6. In the present example, the server apparatus 1, the user terminal 2, the fog server 4, and the AI model developer terminal 6 are configured to be capable of mutual communication via a network 5 such as the Internet, for example.

The server apparatus 1, the user terminal 2, the fog server 4, and the AI model developer terminal 6 are each configured as an information processing apparatus including a microcomputer having a CPU (Central Processing Unit), a ROM (Read Only Memory), and a RAM (Random Access Memory).

Here, the user terminal 2 is an information processing apparatus that is supposed to be used by a user who is a recipient of a service using the information processing system 100. In addition, the server apparatus 1 is an information processing apparatus that is supposed to be used by a service provider.

For example, each camera 3 includes an image sensor such as a CCD (Charge Coupled Device) type image sensor or a CMOS (Complementary Metal Oxide Semiconductor) type image sensor, captures images of subjects, and obtains image data (captured-image data) as digital data. In addition, as described later, each camera 3 also has a function to perform AI processing which is a process using an AI model on captured images.

Each camera 3 is configured to be capable of data communication with the fog server 4, and, for example, is made capable of transmitting, to the fog server 4, various types of data such as processing result information representing results of image processing using an AI model and receiving various types of data from the fog server 4.

Here, the information processing system 100 depicted in FIG. 1 is supposed to be used to cause the fog server 4 or the server apparatus 1 to generate analysis information regarding subjects on the basis of information (hereinafter, expressed as “processing result information”) representing AI processing results obtained by AI processing performed by each camera 3, and allow a user to view the generated analysis information via a user terminal 2.

In this case, it is possible that each camera 3 is used as various types of monitoring cameras. For example, the cameras 3 can be used as monitoring cameras for indoor spaces such as stores, offices, or houses, monitoring cameras (including traffic monitoring cameras and the like) for monitoring outdoor spaces at parking lots, in town, and so on, monitoring cameras of manufacturing lines in FA (Factory Automation) or IA (Industrial Automation), monitoring cameras that monitor the insides of vehicles or the outsides of vehicles, and the like.

For example, in a case where the cameras 3 are used as monitoring cameras in a store, it is possible that each of the multiple cameras 3 is arranged at a predetermined position in the store to allow a user to check customer segments (genders, age brackets, etc.) of in-store customers, behaviors (the lines of flow) of in-store customers in the store, and the like. In this case, it is possible that, as the analysis information described above, information regarding the customer segments of the in-store customers, information regarding the lines of flow of in-store customers in the store, information regarding the congestion state at payment cash registers (e.g., information regarding waiting time of the payment cash registers), and the like are generated.

Alternatively, in a case where the cameras 3 are used as traffic monitoring cameras, it is possible that each camera 3 is arranged at a position near a road to allow a user to recognize such information as the number (vehicle number), a vehicle color, or a vehicle model of a passing vehicle. In this case, it is possible that, as the analysis information described above, such information as the number, the vehicle color, or the vehicle model is generated.

In addition, in a case where traffic monitoring cameras are used in a parking lot, it is possible that the cameras are arranged such that they can monitor each parked vehicle, monitor whether there is a suspicious person who is exhibiting a suspicious behavior around each vehicle, and so on, and, in a case where there is a suspicious person, issue a notification that there is a suspicious person, issue a notification of the attribute (gender, age bracket, cloth, etc.) of the suspicious person, and so on.

Further, it is also possible that available spaces in town or a parking lot are monitored to notify a user of the location of a space where she/he can park her/his vehicle, for example.

For example, in a case of the use for monitoring of a store described above, it is supposed that the fog server 4 is arranged for each monitoring target by, for example, being arranged in the monitoring-target store along with each camera 3. By providing the fog server 4 for each monitoring target such as a store in such a manner, it becomes unnecessary for the server apparatus 1 to directly receive transmission data from multiple cameras 3 at the monitoring target, and it is possible to attempt to reduce the processing load of the server apparatus 1.

Note that it is also possible that, in a case where there are multiple monitoring-target stores and all the stores are stores belonging to the same chain, the fog server 4 is not provided for each store and provided singly for the multiple stores. That is, the fog server 4 is not necessarily provided singly for each monitoring target, and can also be provided singly for multiple monitoring targets.

Note that, in a case where functions of the fog server 4 can be given on the side of the server apparatus 1 or each camera 3 for such a reason that the side of the server apparatus 1 or each camera 3 has processing power, for example, the fog server 4 may be omitted from the information processing system 100, each camera 3 may be connected directly to the network 5, and transmission data from multiple cameras 3 may be received directly by the server apparatus 1.

The AI model developer terminal 6 is an information processing apparatus used by an AI model developer.

The server apparatus 1 is an information processing apparatus having functions to comprehensively manage the information processing system 100.

As functions related to management of the information processing system 100, as depicted in the figure, the server apparatus 1 has a license authorization function F1, an account service function F2, a marketplace function F3, and an AI service function F4.

The license authorization function F1 is a function to perform processes related to various types of authentication. Specifically, the license authorization function F1 enables a process related to device authentication of each camera 3 and a process related to authentication of data concerning AI models or the like used at cameras 3.

Regarding authentication of cameras 3, the license authorization function F1 enables a process of issuing a device ID for each camera 3 in a case where connection is established with the camera 3 via the network 5 (in the present example, the connection is established via the fog server 4).

In addition, regarding authentication of AI models, the license authorization function F1 enables a process of issuing an ID (AI model ID) unique to each AI model for which the AI model developer terminal 6 has applied for registration.

In addition, the license authorization function F1 enables a process of issuing, for the manufacturers of cameras 3 (particularly, the manufacturers of image sensors 30 described later) and AI model developers, various types of keys, certificates, or the like for enabling secure communication between the cameras 3 or the AI model developer terminal 6 and the server apparatus 1, and also enables a process for invalidating the certificates or updating the validity of the certificates.

Further, the license authorization function F1 also enables a process of associating a camera 3 (device ID described above) purchased by a user and a user ID in a case where user registration (account information registration involving issuance of the user ID) is performed using the account service function F2 explained below.

The account service function F2 is a function to generate and manage user account information. With the account service function F2, input of user information is accepted, and account information is generated on the basis of the input user information (account information including at least a user ID and password information is generated).

In addition, the account service function F2 also enables a registration process (account information registration) regarding AI model developers.

In the present example, the marketplace function F3 is a function to perform processes related to a purchase procedure for allowing users to use AI models in a subscription-service-like manner. Subscription services described here means services in which users are permitted to use AI models according to use conditions specified in contracts, after the users have paid purchase prices. Specifically, in the present example, subscription services are services in which, for example, users are permitted to use AI models for a predetermined period such as a one-month period after the users have paid purchase prices. At this time, each user is allowed to select use conditions of an AI model such as a use period from multiple conditions. In addition, different purchase prices can be set according to use conditions.

Here, the phrase “license contract period” is used in the present specification. The license contract period means a license period of an AI model specified in a contract of an AI model subscription service. For example, in the contract of a one-month period illustrated in the description above, the one-month period corresponds to the license contract period.

Each user is allowed to perform a purchase procedure for obtaining a license of an AI model, via a subscription contract WEB site (contract site) provided by the marketplace function F3. For example, the contract site allows selection of an AI model that a user is to use and selection of a license contract period. When the AI model that the user is to use and the license contract period are selected, a purchase price corresponding to them is displayed, and the payment of the purchase price by the user concludes a use contract of the AI model.

The AI service function F4 is a function for providing services related to use of cameras 3 as AI cameras to users.

For example, part of the AI service function F4 includes a function related to generation of analysis information described before. That is, it is a function to perform a process for generating analysis information regarding subjects on the basis of processing result information regarding AI processing at a camera 3 and allowing a user to view the generated analysis information via a user terminal 2.

Here, whereas the server apparatus 1 singly realizes the license authorization function F1, the account service function F2, the marketplace function F3, and the AI service function F4 in the configuration illustrated in the description above, these functions are realized by being divided and allocated to multiple information processing apparatuses in another possible configuration. For example, it is possible that each of the functions described above is performed by one information processing apparatus, in another possible configuration. Alternatively, it is also possible that a single function among the functions described above is divided and allocated to multiple information processing apparatuses to be performed by them.

### (1-2. Configuration of Information Processing Apparatus)

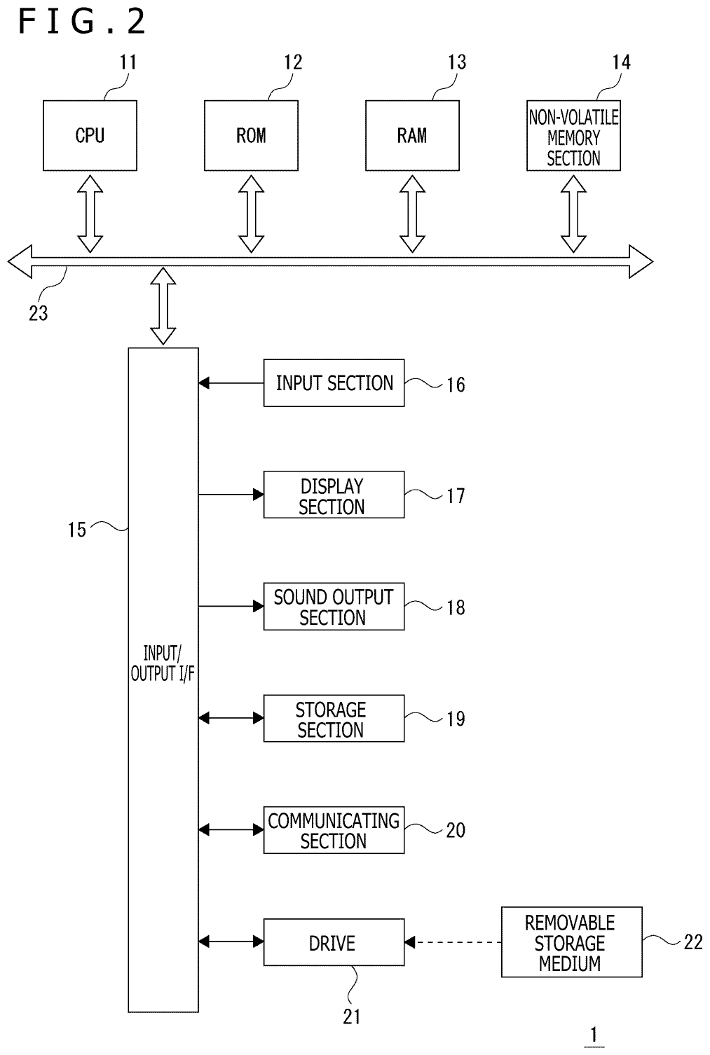

FIG. 2 is a block diagram depicting a hardware configuration example of the server apparatus 1.

As depicted in the figure, the server apparatus 1 includes a CPU 11. The CPU 11 functions as a computation processing section that performs various types of processes explained thus far as processes performed by the server apparatus 1, and executes various types of processes according to programs stored on a ROM 12 or a non-volatile memory section 14 such as an EEP-ROM (Electrically Erasable Programmable Read-Only Memory), for example, or programs loaded from a storage section 19 onto a RAM 13. Also, data necessary for execution of the various types of processes by the CPU 11, for example, is stored as appropriate on the RAM 13.

The CPU 11, the ROM 12, the RAM 13, and the non-volatile memory section 14 are interconnected via a bus 23. The bus 23 is also connected with an input/output interface (I/F) 15.

The input/output interface 15 is connected with an input section 16 including a control element or an operation device. For example, the input section 16 is supposed to be any of various types of control elements or operation devices such as a keyboard, a mouse, a key, a dial, a touch panel, a touch pad, or a remote controller.

User operation is sensed by the input section 16, and a signal according to the input operation is interpreted by the CPU 11.

In addition, the input/output interface 15 is connected with, as integrated or separate bodies, a display section 17 including an LCD (Liquid Crystal Display), an organic EL (Electro-Luminescence) panel, or the like and a sound output section 18 including a speaker or the like.

The display section 17 is used for displaying various types of information, and includes, for example, a display device provided to the housing of a computer apparatus, a display device which is a separate body connected to the computer apparatus, or the like.

The display section 17 executes displaying of images for various types of image processing, processing-target videos, and the like on a display screen on the basis of instructions of the CPU 11. In addition, the display section 17 displays various types of operation menus, icons, messages, or the like, that is, performs displaying as a GUI (Graphical User Interface), on the basis of instructions of the CPU 11.

The input/output interface 15 is connected with the storage section 19 including an HDD (Hard Disk Drive), a solid memory, or the like and a communicating section 20 including a modem or the like, in some cases.

The communicating section 20 performs a communication process via a transfer path such as the Internet, wired/wireless communication with various types of equipment, and communication by bus communication or the like.

The input/output interface 15 is also connected with a drive 21 as necessary, and a removable storage medium 22 such as a magnetic disc, an optical disc, a magneto-optical disc, or a semiconductor memory is attached to the drive 21 as appropriate.

The drive 21 makes it possible to read out, for example, data files of programs or the like used for processes, from the removable storage medium 22. The data files having been read out are stored on the storage section 19, and images or sounds included in the data files are output at the display section 17 or the sound output section 18, for example. In addition, computer programs or the like having been read out from the removable storage medium 22 are installed on the storage section 19 as necessary.

On the computer apparatus having the hardware configuration described above, for example, software for processes of the present embodiment can be installed via network communication by the communicating section 20 or via the removable storage medium 22. Alternatively, the software may be stored in advance on the ROM 12, the storage section 19, or the like.

By the CPU 11 performing processing operations on the basis of various types of programs, information processing or communication processing as necessary processes performed by the server apparatus 1 described before is executed.

Note that the server apparatus 1 is not necessarily configured singly with a computer apparatus as depicted in FIG. 2, and may be configured by systemization of multiple computer apparatuses. The multiple computer apparatuses may be systemized with use of a LAN (Local Area Network) or the like, or may be arranged remotely with use of a VPN (Virtual Private Network) or the like using the Internet or the like. The multiple computer apparatuses may include a computer apparatus as a server group (cloud) that can be used by a cloud computing service.

### (1-3. Configuration of Image-Capturing Apparatus)

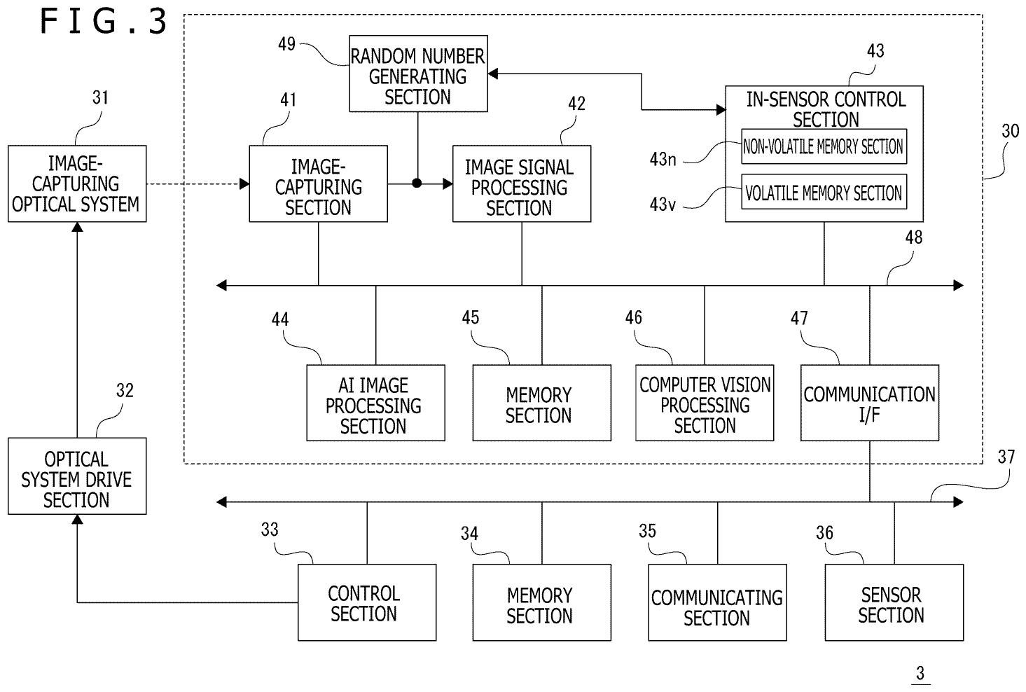

FIG. 3 is a block diagram depicting a configuration example of a camera 3.

As depicted in the figure, the camera 3 includes an image sensor 30, an image-capturing optical system 31, an optical system drive section 32, a control section 33, a memory section 34, a communicating section 35, and a sensor section 36. The image sensor 30, the control section 33, the memory section 34, the communicating section 35, and the sensor section 36 are connected to each other via a bus 37, and it is made possible for them to perform data communication mutually.

The image-capturing optical system 31 includes lenses such as a cover lens, a zoom lens, or a focus lens and an aperture (iris) mechanism. The image-capturing optical system 31 guides light (incident light) from a subject, and concentrates the light onto the light reception surface of the image sensor 30.

The optical system drive section 32 comprehensively represents drive sections of the zoom lens, the focus lens, and the aperture mechanism of the image-capturing optical system 31. Specifically, the optical system drive section 32 has actuators for driving the zoom lens, the focus lens, and the aperture mechanism and a drive circuit of the actuators.

For example, the control section 33 includes a microcomputer having a CPU, a ROM, and a RAM, and performs overall control of the camera 3 by causing the CPU to execute various types of processes according to programs stored on the ROM or programs loaded onto the RAM.

In addition, the control section 33 gives the optical system drive section 32 drive instructions regarding the zoom lens, the focus lens, the aperture mechanism, and the like. According to the drive instructions, the optical system drive section 32 causes the focus lens or the zoom lens to move, open or close aperture blades of the aperture mechanism, and so on.

In addition, the control section 33 controls the memory section 34 to write and read various types of data.

For example, the memory section 34 is a non-volatile storage device such as an HDD or a flash memory apparatus, and is used for storage of data to be used when the control section 33 executes various types of processes. In addition, the memory section 34 can be used also as the storage destination (recording destination) of image data output from the image sensor 30.

The control section 33 performs various types of data communication with an external apparatus via the communicating section 35. The communicating section 35 in the present example is configured to be capable of data communication at least with the fog server 4 depicted in FIG. 1.

Alternatively, the communicating section 35 is made capable of communication via the network 5 and performs data communication with the server apparatus 1, in some cases.

The sensor section 36 comprehensively represents sensors other than the image sensor 30 included in the camera 3. For example, examples of the sensors that the sensor section 36 has include a GNSS (Global Navigation Satellite System) sensor and an altitude sensor for sensing the position and altitude of the camera 3, a temperature sensor for sensing an environmental temperature, a motion sensor such as an acceleration sensor or an angular velocity sensor for sensing motions of the camera 3, and the like.

For example, the image sensor 30 is configured as a solid-state image-capturing element of a CCD type, a CMOS type, or another type, and, as depicted in the figure, includes an image-capturing section 41, an image signal processing section 42, an in-sensor control section 43, an AI image processing section 44, a memory section 45, a computer vision processing section 46, a communication interface (I/F) 47, and a random number generating section 49. Of these sections, the sections excluding the random number generating section 49 are configured to be capable of mutual data communication via a bus 48.

The image sensor 30 is one embodiment of the sensor apparatus according to the present technology.

The image-capturing section 41 includes a pixel array section in which pixels having photoelectric converting elements such as photodiodes are arrayed two-dimensionally and a read circuit that reads out electric signals obtained by photoelectric conversion of signals from respective pixels included in the pixel array section.

In the read circuit, for example, a CDS (Correlated Double Sampling) process, an AGC (Automatic Gain Control) process, and the like are executed on electric signals obtained by photoelectric conversion, and an A/D (Analog/Digital) conversion process is further performed on the electric signals.

The image signal processing section 42 performs preprocessing, synchronization processing, YC generation processing, resolution conversion processing, codec processing, and the like on captured-image signals as digital data obtained after the A/D conversion process.

In the preprocessing, a clamping process of clamping R (red), G (green), and B (blue) black levels of captured-image signals at a predetermined level, a correction process among R, G, and B color channels, and the like are performed. In the synchronization processing, a color separation process of making image data of each pixel have color components of all of R, G, and B is implemented. For example, in a case of image-capturing elements using Bayer-array color filters, a demosaicing process is performed as the color separation process. In the YC generation processing, luminance (Y) signals and color (C) signals are generated (separated) from R, G, and B image data. In the resolution conversion processing, resolution conversion processing is executed on image data having been subjected to various types of signal processing.

In the codec processing, for example, an encoding process and file generation for recording and communication are performed on the image data having been subjected to the various types of processes described above. In the codec processing, for example, it is made possible to perform generation of files in such formats as MPEG-2 (MPEG: Moving Picture Experts Group) or H. 264 as video file formats. In addition, it is also possible that generation of files in such formats as JPEG (Joint Photographic Experts Group), TIFF (Tagged Image File Format), or GIF (Graphics Interchange Format) as still image files is performed.

For example, the in-sensor control section 43 includes a microcomputer having a CPU, a ROM, a RAM, and the like, and comprehensively controls operations of the image sensor 30. For example, the in-sensor control section 43 gives an instruction to the image-capturing section 41, and performs execution control of an image-capturing operation. In addition, the in-sensor control section 43 also performs process execution control of the AI image processing section 44, the image signal processing section 42, and the computer vision processing section 46.

In addition, the in-sensor control section 43 performs such a process that an AI model is set in the AI image processing section 44 when the AI model is transmitted from the server apparatus 1 to the image sensor 30, as described later. That is, the process is a process of setting the AI model in the AI image processing section 44 such that it becomes possible for the AI image processing section 44 to execute AI processing using the AI model.

The in-sensor control section 43 has a non-volatile memory section 43n and a volatile memory section 43v. The non-volatile memory section 43n is used for storage of data to be used by the CPU of the in-sensor control section 43 in various types of processes. In addition, data to be used by the CPU of the in-sensor control section 43 in various types of processes is temporarily stored on the volatile memory section 43v.

As also described later, in the present example, information regarding various types of keys for decrypting data transmitted from the server apparatus 1 such as AI models is stored on the non-volatile memory section 43n. For example, these keys are keys to be shared by the server apparatus 1 and the authenticated camera 3 through the license authorization function F1 described before.

In addition, in the in-sensor control section 43, the volatile memory section 43v is used also for temporary storage of license data described later.

In addition, the in-sensor control section 43 is connected with the random number generating section 49. On the basis of captured-image data obtained by the image-capturing section 41, the random number generating section 49 generates a random number to be used when an authentication process between the server apparatus 1 and the image sensor 30 (in-sensor control section 43) described later is performed. Note that processes performed by the random number generating section 49 including the authentication process are explained later on.

For example, the AI image processing section 44 has a programmable computation processing apparatus such as a CPU, an FPGA (Field Programmable Gate Array), or a DSP (Digital Signal Processor), and performs AI processing on captured images.

For example, examples of AI processing performed by the AI image processing section 44 include an image recognition process of recognizing subjects as particular targets such as humans or vehicles. Alternatively, it is also possible that, as AI processing, an object sensing process of sensing whether or not there is some object no matter what the type of the subject is is performed.

Functions of AI processing performed by the AI image processing section 44 enable switching by changing AI models (algorithms of AI processing). AI processing is an image recognition process in examples of cases to be explained hereinbelow.

There is a variety of specific function types of image recognition, and, for example, examples thereof include types illustrated below.
Class identification
Semantic segmentation
Human sensing
Vehicle sensing
Target tracking
OCR (Optical Character Recognition)

Class identification in the function types described above is a function to identify the classes of targets. The classes described here are information representing the categories of objects, and, for example, are ones that make distinctions between “human,” “automobile,” “airplane,” “ship,” “truck,” “bird,” “cat,” “dog,” “deer,” “frog,” “horse,” and the like.

Target tracking is a function to track target subjects, and is one that can be said differently as a function to obtain history information regarding the positions of the subjects.

The memory section 45 includes a non-volatile memory, and is used for storage of data required for the AI image processing section 44 to perform AI processing. Specifically, settings data concerning an AI model (e.g., various types of weighting factors used in convolutional computation of a neural network, data representing a neural network structure, etc.) is stored on the memory section 45.

In addition, in the present example, the memory section 45 is used also for retaining captured-image data processed by the image signal processing section 42.

The computer vision processing section 46 implements rule-based image processing as image processing on captured-image data. For example, examples of the rule-based image processing here include super-resolution processing and the like.

The communication interface 47 is an interface that performs communication with respective sections connected thereto via the bus 37, such as the control section 33 or the memory section 34 provided outside the image sensor 30. For example, on the basis of control by the in-sensor control section 43, the communication interface 47 performs communication for externally acquiring AI models to be used by the AI image processing section 44, for example.

In addition, processing result information regarding AI processing by the AI image processing section 44 is output to the outside of the image sensor 30 via the communication interface 47.

Here, in the image sensor 30, the in-sensor control section 43 is made capable of data communication with the server apparatus 1 via the communication interface 47, the communicating section 35, and the fog server 4. Accordingly, the in-sensor control section 43 is made capable of receiving various types of data such as AI models from the server apparatus 1, transmitting various types of data such as information regarding results of processing by the AI image processing section 44, or the like to the server apparatus 1, as described later.

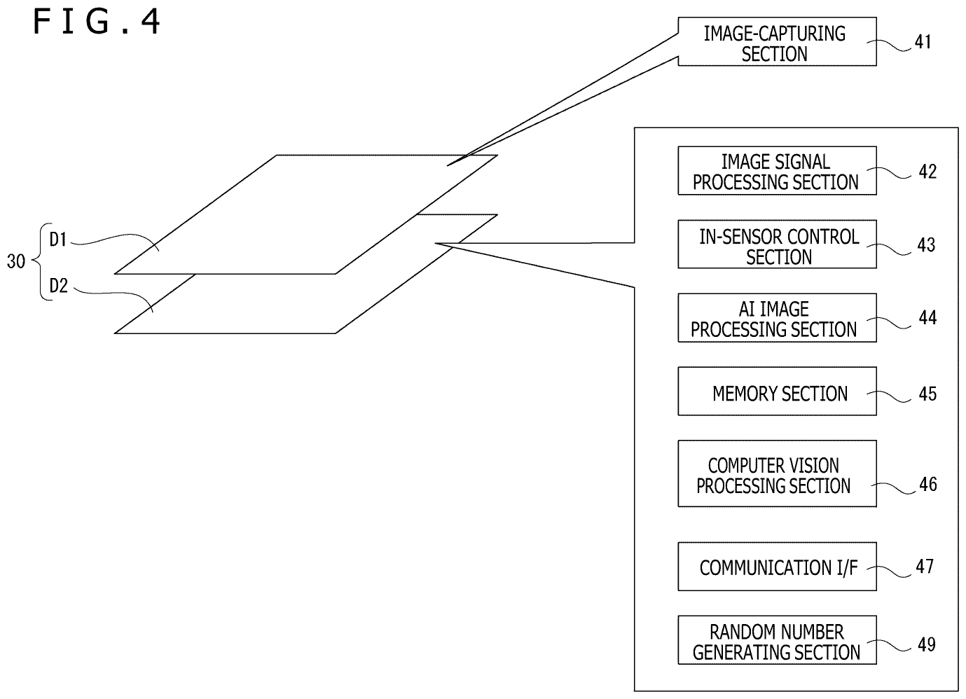

Meanwhile, in the present example as in the explanation described above, the image sensor 30 has the AI image processing section 44 that performs AI processing, the in-sensor control section 43 as a computer apparatus, and the like, in addition to the image-capturing section 41 having a pixel array section. A structural example of such an image sensor 30 is explained with reference to FIG. 4. Note that the structure depicted in FIG. 4 is merely an example, and, needless to say, other structures can also be adopted.

As depicted in FIG. 4, the image sensor 30 in the present example has a dual-layer structure (stacked structure) in which two dies, which are a die D1 and a die D2, are stacked one on another. Specifically, the image sensor 30 in the present example is configured as a one-chip semiconductor apparatus in which the die D1 and the die D2 are pasted together. The die D1 is a die in which the image-capturing section 41 is formed, and the die D2 is a die including the image signal processing section 42, the in-sensor control section 43, the AI image processing section 44, the memory section 45, the computer vision processing section 46, the communication interface 47, and the random number generating section 49.

For example, the die D1 and the die D2 are physically and electrically connected to each other by an inter-chip junction technology such as Cu-Cu junction.

### 2. Functions as Embodiment

In the present embodiment, the server apparatus 1 has various types of functions depicted below, as functions as an embodiment.

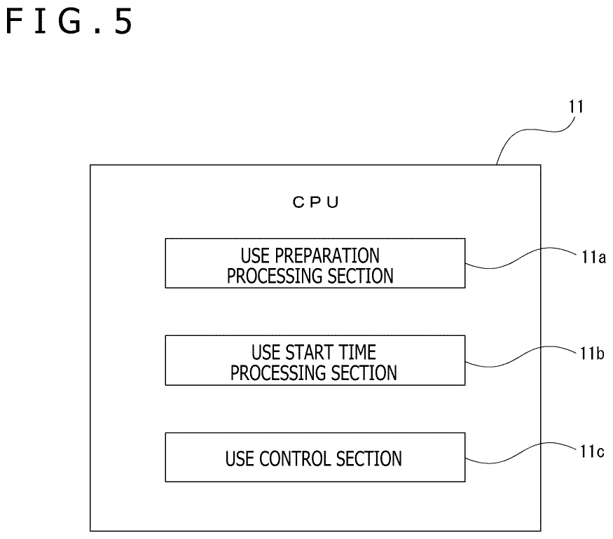

FIG. 5 is a functional block diagram for explaining functions as an embodiment that the CPU 11 of the server apparatus 1 has.

As depicted in the figure, the server apparatus 1 has functions as a use preparation processing section 11a, a use start time processing section 11b, and a use control section 11c.

The use preparation processing section 11a performs a process related to preparation for a user to receive a service by the information processing system 100.

Here, in the present example, a user purchases cameras 3 as compatible products that support use in the information processing system 100, when the user is to receive the service by the information processing system 100.

Then, as a procedure before the start of use, the user performs a procedure for registration of the purchased cameras 3 or a user account.

Specifically, the user establishes network connection between all the purchased cameras 3 that she/he desires to use and a designated cloud, that is, the server apparatus 1 in the present example.

In this state, the user inputs information for registration of the cameras 3 and a user account to the server apparatus 1 (the account service function F2 described before) by using a user terminal 2.

The use preparation processing section 11a generates user account information on the basis of the information input by the user. Specifically, account information including at least a user ID and password information is generated.

In addition, the use preparation processing section 11a performs a process of generating the user account information, acquiring, from the connected cameras 3, sensor IDs (IDs of the image sensors 30), camera IDs (IDs of the cameras 3), Region information (information regarding an installation location of the cameras 3), and the like, and associating the acquired information with the generated account information.

In addition, the use preparation processing section 11a performs a process of giving IDs to the cameras 3 of the account-registered user by using the license authorization function F1 described before. That is, the use preparation processing section 11a issues a corresponding device ID for each connected camera 3, and associates the device ID with its camera ID described above, for example. As a result, it becomes possible for the server apparatus 1 to identify each camera 3 by its device ID.

Further, the use preparation processing section 11a performs a process of accepting an AI model purchase made by a user and a purchase handling process. That is, the use preparation processing section 11a performs a process of accepting an AI model purchase in the marketplace described before, specifically, in the present example, a process for accepting selection of an AI model to be used, selection of a license contract period, and a procedure of the payment of a purchase price, and also performs a process of associating the purchased AI model and a user ID in response to the payment of the purchase price.

Here, in the present example, the server apparatus 1 manages AI models by using content IDs. The content IDs are IDs used for identifying AI models in purchasable units. For example, for AI models each of which can be purchased only singly, a different content ID is allocated to each AI model. In addition, for sets of AI models, each set of which includes multiple AI models that can be purchased together, one content ID is allocated to each set of multiple AI models. The server apparatus 1 is made capable of managing which AI models have been purchased by users, by using the content IDs.

In addition, the use preparation processing section 11a performs an AI model encryption process. In the present example, the encryption process is performed as a process of generating an AI model encryption key by multiplying a content ID described above by predetermined key information, and encrypting an AI model which is given a corresponding content ID, by using the AI model encryption key.

The use start time processing section 11b performs a process related to use start time of a camera 3. Specifically, the use start time processing section 11b performs a process of deploying an encrypted AI model on an image sensor 30.

“Deployment” of an AI model described here means transmitting the AI model to an image sensor 30 for installing the AI model on the image sensor 30.

The use control section 11c performs a process for controlling use of an AI model in an image sensor 30. Specifically, the control is use control of an AI model based on a license contract period described before.

Here, after deployment of an AI model by the use start time processing section 11b as described above is performed, the in-sensor control section 43 makes an AI model use start request to the server apparatus 1 when a predetermined condition is satisfied.

According to such an AI model use start request from the side of the image sensor 30, the use control section 11c generates license data on the basis of information regarding a license contract period associated with the image sensor 30.

The license data described here is data including information (hereinafter, expressed as “use upper limit condition information”) representing a use upper limit condition related to the AI model. By transmitting the license data to the side of the image sensor 30, it becomes possible to cause execution control of AI processing to be performed on the side of the image sensor 30 such that the use upper limit condition is satisfied.

In addition, in the present example, an AI model encryption key is included in the license data. As a result, it becomes impossible to decrypt the encrypted AI model on the side of the image sensor 30 unless the license data is received. That is, the AI model becomes unusable.

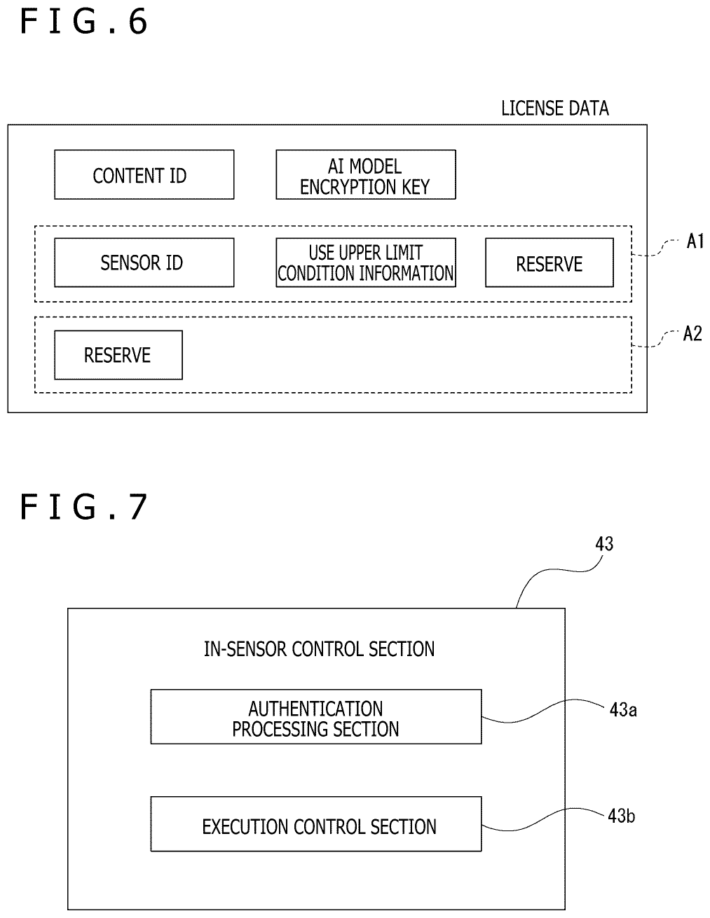

FIG. 6 depicts a data structural example of license data.

As depicted in the figure, license data in the present example includes at least a content ID, an AI model encryption key, a sensor ID, and use upper limit condition information.

In the present example, a required data area A1 and an option data area A2 are specified in the license data. The required data area A1 is a data area in which, if there is an unknown value when the license data is read on the side of an image sensor 30, the received license data is treated as invalid data. The option data area A2 is a data area in which, even if there is an unknown value when the license data is read on the side of the image sensor 30, the received license data is not treated as invalid data.

As depicted in the figure, the sensor ID and the use upper limit condition information are stored in the required data area A1 described first. In addition, the content ID and the AI model encryption key are stored in a data area belonging to neither the required data area A1 nor the option data area A2.

A reserve area is reserved in the required data area A1. In addition, a reserve area is reserved also in the option data area A2.

It is possible that information for designating conditions different from the use upper limit condition information, such as information regarding the upper limit of the number of times of image recognition by the AI image processing section 44, for example, is stored in the reserve area in the required data area A1. In addition, it is possible that, for example, information regarding a flag representing whether conversion-output to another marketplace is enabled, and the like are stored in the reserve area in the option data area A2.

As the sensor ID, the sensor ID of the image sensor 30 that has made a use start request is stored in the license data. The sensor ID is stored in the license data for attempting to prevent an image sensor 30 (incompatible product) other than the image sensor 30 as a compatible product that has made the use start request from undesirably being able to fraudulently use an AI model.

In addition, in the present example, as the use upper limit condition information, information representing a use period shorter than a license contract period is stored in the license data.

Note that it is also possible to store, as the AI model encryption key in the license data, a key obtained by encryption with some key.

In addition, the examples described above are not the sole examples of information to be stored in the license data.

For example, in a case where multiple management techniques can be selected as use upper limit condition management techniques on the side of an image sensor 30, it is also possible that information representing by which management technique a use upper limit condition should be managed is included in the license data.

Here, it is premised in the present example that cameras 3 are not activated continuously for 24 hours and, for example, the power supplies of the cameras 3 are interrupted in a predetermined time period in each day such as a time period outside business hours of a store. Stated differently, the power supply interruption and activation of the cameras 3 are repeated daily.

Further, in the present example, the image sensors 30 have such specifications that AI model use start requests are made every time the image sensors 30 are activated.

In the present example, as the use upper limit condition information stored in the license data, the use control section 11c stores the information representing the use period shorter than the license contract period, as described above, and such license data is transmitted to the side of an image sensor 30 multiple times in the license contract period. That is, in the present example, every time an image sensor 30 makes an AI model use start request when the image sensor 30 is activated (daily, in the present example), the license data is transmitted to the requester image sensor 30.

At this time, the information representing the use period shorter than the license contract period, specifically, for example, information representing a predetermined use period equal to or shorter than 24 hours if it is premised, for example, that the power supply is interrupted daily as described above, is stored in the license data.

In a case where there is a use start request from the side of an image sensor 30, on the basis of information regarding a sensor ID of the requester image sensor 30, the use control section 11c checks corresponding contract details, specifically, a license contract period, and, if the current time is in the license contract period, generates license data including use upper limit condition information representing a use period shorter than the license contract period. Specifically, in the present example, license data including the use upper limit condition information and the sensor ID acquired from the requester image sensor 30 is generated. Then, the license data is transmitted to the requester image sensor 30 (in-sensor control section 43).

On the side of the image sensor 30, the in-sensor control section 43 performs execution control of AI processing according to the license data received from the server apparatus 1. In the present example, the execution control of AI processing is performed every time the license data is received from the server apparatus 1 in the license contract period (daily, in the present example) such that the execution period of AI processing does not exceed a predetermined use period which is equal to or shorter than 24 hours, for example.

As a result, the use period of an AI model at the image sensor 30 can be restricted to be within the license contract period.

Here, the use control section 11c performs, with the in-sensor control section 43, an authentication process regarding the license data when the license data is transmitted to the side of the image sensor 30. In the present example, challenge response authentication is performed as the authentication process. By adopting the challenge response authentication, it is possible to enhance the tolerance against replay attacks (replay attacks).

In addition, by adopting the challenge response authentication for the authentication process regarding the license data, the encryption key of the license data becomes a key which is valid only for one session. Stated differently, the license data is a volatile license which is valid only for one session. By making the license data a volatile license in such a manner, it becomes possible to transmit, as the license data to the image sensor 30, data for which a condition corresponding to a use upper limit period shorter than the license contract period is specified as the use upper limit condition, multiple times in the license contract period.

Note that the challenge response authentication is explained later on.

Next, functions of an embodiment realized by the server apparatus 1 described above, specifically, functions that an in-sensor control section 43 has corresponding to the functions of the use control section 11c, are explained with reference to the functional block diagram in FIG. 7.

As depicted in FIG. 7, the in-sensor control section 43 has an authentication processing section 43a and an execution control section 43b.

The authentication processing section 43a performs an authentication process with the server apparatus 1 (CPU 11) every time license data is transmitted from the side of the server apparatus 1. Specifically, in the present example, the challenge response authentication described above is performed.

In addition, the authentication processing section 43a in the present example decrypts a deployed encrypted AI model on the basis of an AI model encryption key included in license data, in a case where authentication of the license data is successful.

Further, the authentication processing section 43a in the present example also performs an authentication process based on a sensor ID included in the license data. Specifically, the authentication processing section 43a collates the sensor ID stored in the license data and a sensor ID stored on the subject apparatus (image sensor 30), and determines whether or not the two IDs match. The authentication process based on a sensor ID is performed every time the license data is received (every time authentication of the license data is successful).

In addition, in the present example, along with license data, tampering determination data which is data for determining whether or not the license data has been tampered with is transmitted from the server apparatus 1.

On the basis of the tampering determination data, the authentication processing section 43a also performs a process of determining whether or not the license data has been tampered with.

In a case where any one of the types of authentication performed by the authentication processing section 43a, which are the authentication (challenge response authentication) with the side of the server apparatus 1, the authentication using a sensor ID as described above, and the authentication by tampering determination based on tampering determination data described above, is not successful, execution control of AI processing based on received license data is not performed. That is, AI processing is not executed on the side of the image sensor 30.

Here, in the present example, license data which has been encrypted is transmitted from the server apparatus 1. Because of this, the authentication processing section 43a also performs a process of decrypting license data having been encrypted.

Note that details of processes performed by the authentication processing section 43a including also such decryption of license data are explained later on.

On the basis of use upper limit condition information included in license data, the execution control section 43b performs execution control of AI processing performed by the AI image processing section 44, such that a use upper limit condition represented by the use upper limit condition information is satisfied. Specifically, the execution control section 43b performs execution control of AI processing based on the use upper limit condition described above under a condition that the various types of authentication performed by the authentication processing section 43a described above are successful.

Here, in the present example, the execution control section 43b performs execution control of AI processing for satisfying the use upper limit condition, on the basis of a count value of the number of processing frames of the AI image processing section 44. Since the processing frame rate of the AI image processing section 44 is known, the processing time of AI processing can be measured by counting the number of processing frames of the AI image processing section 44.

The execution control section 43b in the present example determines whether or not the processing time of AI processing measured on the basis of the processing frame rate of the AI image processing section 44 and a count value of the number of processing frames in the above-described manner has exceeded a use period represented by use upper limit condition information in license data. If the processing time described above has not exceeded the use period described above, the execution control section 43b allows the AI image processing section 44 to continue AI processing, and in a case where the processing time described above has exceeded the use period described above, the execution control section 43b causes the AI image processing section 44 to stop AI processing.

Note that, whereas, in the example in the description above, a count value of the number of processing frames is converted into time and compared with a use period, it is also possible to store, in license data, the value of the number of frames as use upper limit condition information, and, in this case, the process of converting a count value of the number of processing frames into time is unnecessary. As an example, for example, the number of frames per 24 hours in a case where the processing frame rate=30 fps is 2592000 frames according to “24 h×30 m×30 s×30 fps,” and, for example, in a case where it is premised that the use period=24 hours, it is sufficient if information representing the number of frames, “2592000,” is stored as use upper limit condition information.

### 3. Processing Procedure

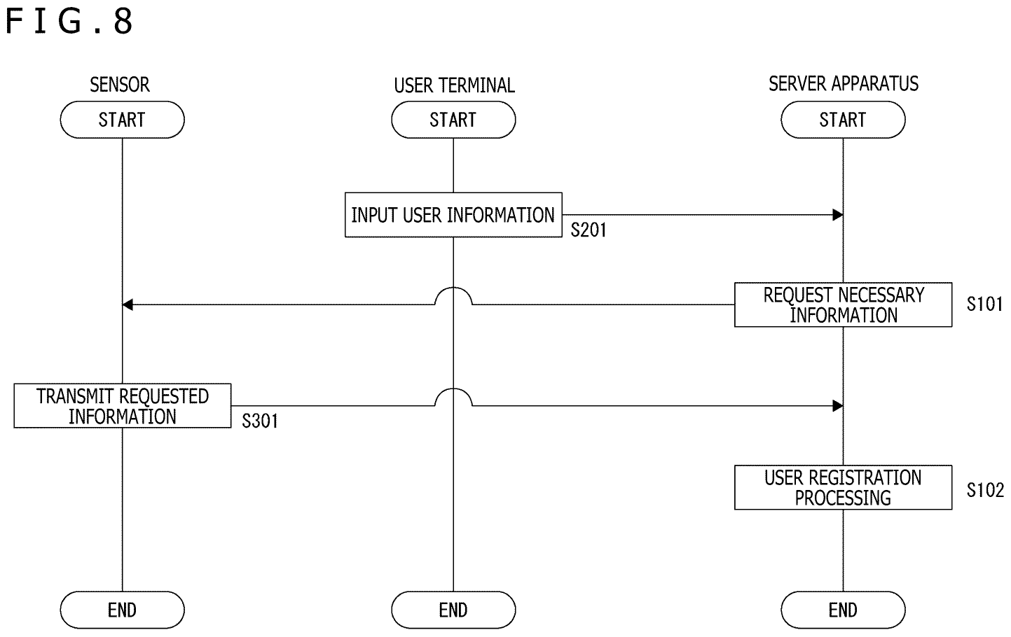

Procedure examples of specific processes that should be performed in the information processing system 100 in order to realize functions as an embodiment explained in the description above are explained with reference to flowcharts in FIG. 8 to FIG. 10.

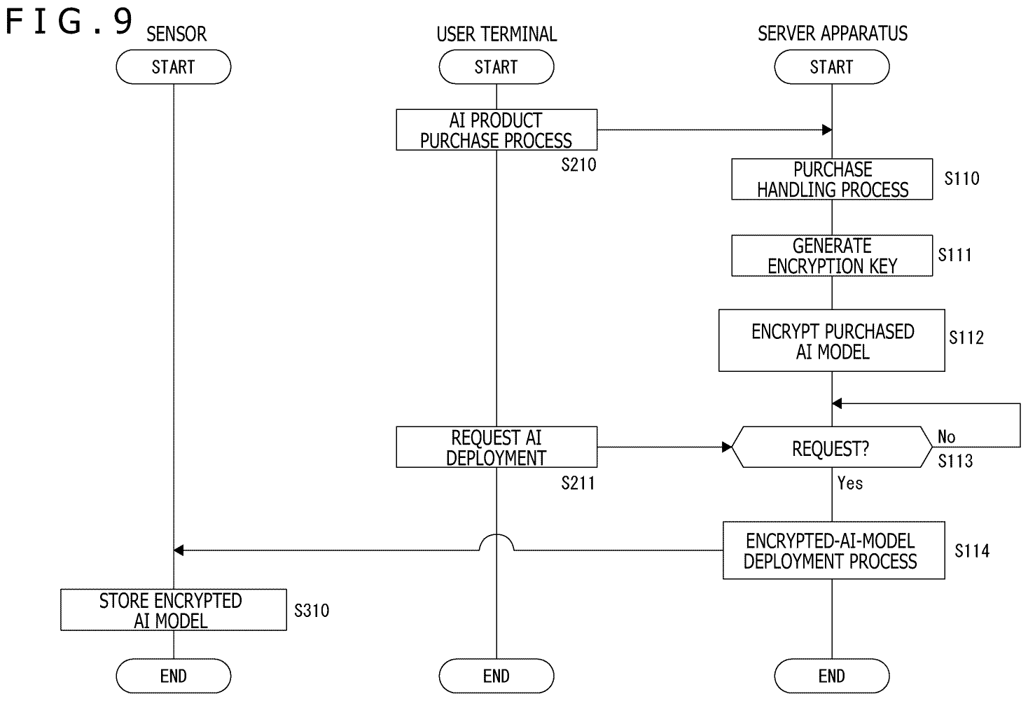

FIG. 8 is a flowchart of processes related to user account registration, and FIG. 9 is a flowchart of processes ranging from an AI model purchase (subscription purchase) to AI model deployment.

In FIG. 8 and FIG. 9, processes depicted under “SERVER APPARATUS” are processes executed by the CPU 11 of the server apparatus 1, and processes depicted under “SENSOR” are processes executed by the in-sensor control section 43 in the image sensor 30 of a camera 3. Note that processes depicted under “USER TERMINAL” are executed by the CPU in a user terminal 2.

Note that it is supposed that, when processes depicted in FIG. 8 and FIG. 9 are started, each of the user terminal 2 and the image sensor 30 has been communicatively connected with the server apparatus 1 via the network 5.

In FIG. 8, at Step S201, the user terminal 2 performs a user information input process. That is, this is a process of inputting information for account registration (information regarding at least a user ID and a password) to the server apparatus 1 on the basis of operation input by a user.

The server apparatus 1 accepts input of the information from the user terminal 2, and, at Step S101, transmits information necessary for account registration to the image sensor 30. Specifically, the server apparatus 1 makes a request for transmission of a sensor ID, a camera ID, Region information, and the like described before that should be associated with the user ID (see the functions of the use preparation processing section 11a described before).

As a requested information transmission process at Step S301, the image sensor 30 performs a process of transmitting information requested by the server apparatus 1 to the server apparatus 1.

As a user registration processing at Step S102, the server apparatus 1 having received the requested information from the image sensor 30 performs a process of generating account information based on the user information input from the user terminal 2 and associating, with the user ID, the above-described requested information received from the image sensor 30.

Next, processes in FIG. 9 are explained.

First, the user terminal 2 executes an AI product purchase process at Step S210. That is, this is a process for purchasing an AI model in the marketplace described before. Specifically, as a process at Step S210, the user terminal 2 performs a process related to transmission of information for giving the server apparatus 1 an instruction regarding a use-target AI model and a selected license contract period on the basis of operation input by the user, and to the payment of a purchase price, for example.

As a purchase handling process at Step S110, the server apparatus 1 performs a process for associating, with the user as the purchaser, information regarding the AI model for which the user terminal 2 has given a purchase instruction and the license contract period. Specifically, the server apparatus 1 performs a process of associating, with the user ID of the user as the purchaser, an ID (AI model ID) of the AI model for which a purchase instruction has been given, a content ID, and information regarding the selected license contract period.

At Step S111 subsequent to Step S110, the server apparatus 1 generates an encryption key. That is, this is a process of generating an AI model encryption key to be used for encrypting the purchased AI model. As illustrated earlier, the AI model encryption key in the present example is generated by multiplying the content ID by predetermined key information.

At Step S112 subsequent to Step S111, the server apparatus 1 encrypts the purchased AI model. Specifically, the server apparatus 1 encrypts the purchased AI model by using the encryption key generated at Step S111.

Note that, whereas an AI model is encrypted when the AI model is purchased in the example here, this is not essential. For example, it is possible that an AI model is encrypted at a timing before a purchase process such as a timing when, for example, the AI model is registered in the marketplace through the AI model developer terminal 6 and a content ID for the AI model is allocated.

In a case where, after the process related to the purchase of the AI product described above is performed, the user wishes to deploy the purchased AI model on each image sensor 30, the user makes a deployment request to the server apparatus 1 by using the user terminal 2 (Step S211 “REQUEST AI DEPLOYMENT”).

After executing the process at Step S112 described above, at Step S113, the server apparatus 1 waits for the deployment request.

In a case where there is the deployment request, at Step S114, the server apparatus 1 performs an encrypted-AI-model deployment process. That is, the server apparatus 1 performs a process of transmitting the encrypted data (encrypted AI model) obtained at Step S112 to a relevant image sensor 30.

At Step S310, the image sensor 30 having received the encrypted AI model transmitted from the server apparatus 1 performs a process for storing the encrypted AI model. That is, the image sensor 30 performs a process of storing the received encrypted AI model on a predetermined non-volatile storage apparatus such as the non-volatile memory section 43n.

Note that, whereas the deployment of the encrypted AI model is performed before an AI model use start request is made from the side of the image sensor 30 in the example here, it is also possible that, for example, the deployment of the encrypted AI model is performed according to the initial use start request from the image sensor 30, and so on.

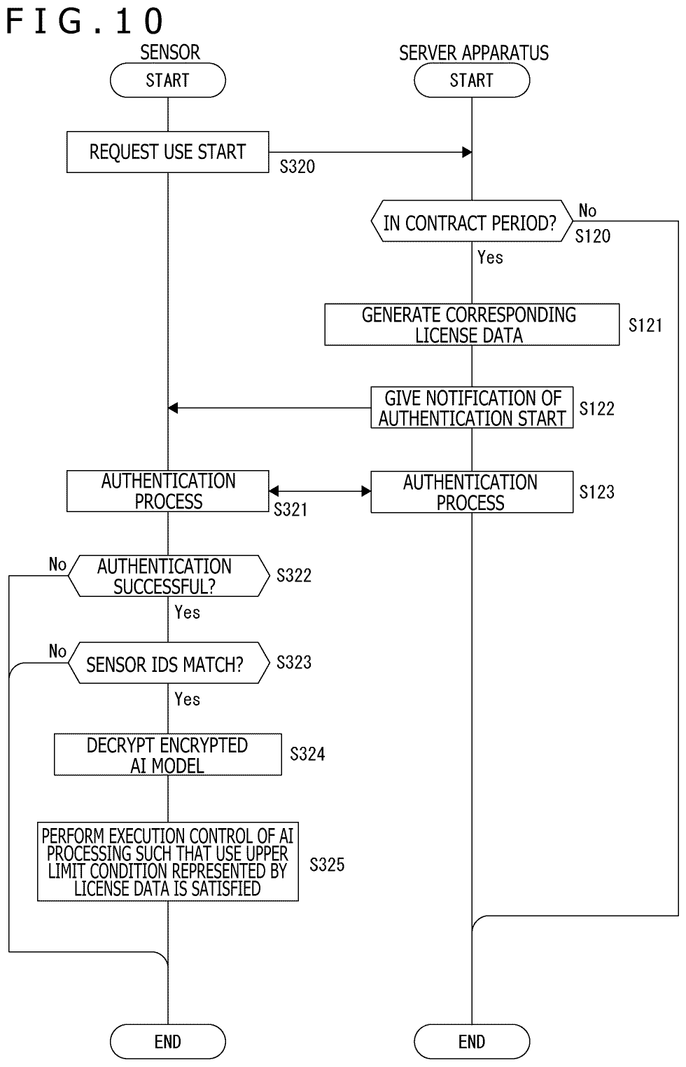

FIG. 10 is a flowchart depicting processes that should be performed by the server apparatus 1 and the image sensor 30 for AI processing execution management based on a license contract period.

Note that, also in FIG. 10, processes depicted under “SERVER APPARATUS” are executed by the CPU 11 of the server apparatus 1 and that processes depicted under “SENSOR” are executed by the in-sensor control section 43 in the image sensor 30. In addition, it is supposed that, when processes depicted in FIG. 10 are started, the image sensor 30 is in the state of being communicatively connected with the server apparatus 1 via the network 5. In the present example, the image sensor 30 (in-sensor control section 43) executes processes depicted in FIG. 10 every time the image sensor 30 is activated.

First, at Step S320, the image sensor 30 makes a use start request to the server apparatus 1. That is, this is an AI model use start request.

After receiving the use start request made at Step S320, the server apparatus 1 determines at Step S120 whether or not the current time is in a contract period. That is, the server apparatus 1 acquires information regarding the license contract period corresponding to the image sensor 30 as the requester of the use start request on the basis of a sensor ID acquired from the image sensor 30 that has made the use start request, and determines whether or not the current time is in the license contract period.

In a case where it is determined at Step S120 that the current time is not in the contract period, the server apparatus 1 ends the series of processing depicted in FIG. 10. That is, in this case, transmission of license data to the image sensor 30 is not performed, execution control at Step S324 described later is not performed on the side of the image sensor 30, and accordingly, the AI model becomes unusable at the image sensor 30.

On the other hand, in a case where it is determined at Step S120 that the current time is in the contract period, the server apparatus 1 proceeds to Step S121, and generates corresponding license data. That is, as explained with reference to FIG. 6 described earlier, license data including at least a content ID, an AI model encryption key, a sensor ID, and use upper limit condition information is generated.

As described before, in the present example, as the use upper limit condition information, information representing a use period shorter than the license contract period is stored in the license data. For example, as described before, if it is premised that the license contract period is such a period as a one-month period that spans across multiple days and that the power supply to the image sensor 30 (camera 3) is interrupted daily, use upper limit condition information representing a use period which is a predetermined time length equal to or shorter than 24 hours, for example, is stored in the license data.

At Step S122 subsequent to Step S121, the server apparatus 1 gives an authentication start notification to the image sensor 30.

In response to this authentication start notification, an authentication process is performed between the image sensor 30 and the server apparatus 1 (see Step S321 and Step S123 in the figure). Specifically, in the present example, processes of the challenge response authentication described later are performed.

Here, although not depicted in FIG. 10, in the course of the authentication process at Step S123, the server apparatus 1 performs a process of encrypting the license data and transmitting the license data having been encrypted and license-data-tampering determination data to the image sensor 30.

In response to the execution of the authentication process at Step S123, the server apparatus 1 ends the series of processing depicted in FIG. 10.

Meanwhile, at Step S322 subsequent to the authentication process at Step S321, the image sensor 30 determines whether or not the authentication is successful. Specifically, the process at Step S322 in the present example is a process of determining whether or not both the types of authentication explained as the authentication processes performed by the authentication processing section 43a in FIG. 7, which are the authentication with the side of the server apparatus 1 (challenge response authentication) and the authentication by tampering determination based on the license-data-tampering determination data, are successful.

In a case where it is determined at Step S322 that the authentication is not successful, the image sensor 30 ends the series of processing depicted in FIG. 10. That is, in this case, an encrypted-AI-model decryption process at Step S324 is not performed, and accordingly, the AI model becomes unusable at the image sensor 30.

On the other hand, in a case where it is determined at Step S322 that the authentication is successful, the image sensor 30 determines at Step S323 whether or not sensor IDs match. That is, it is determined whether or not a sensor ID included in the decrypted license data matches a sensor ID of itself.

In a case where it is determined at Step S323 that the sensor IDs do not match, the image sensor 30 ends the series of processing depicted in FIG. 10. That is, also in this case, the AI model becomes unusable at the image sensor 30.

In a case where it is determined at Step S323 that the sensor IDs match, the image sensor 30 proceeds to Step S324, and decrypts the encrypted AI model. That is, the image sensor 30 decrypts the encrypted AI model stored at Step S310 described earlier (FIG. 9), on the basis of the AI model encryption key included in the license data. As a result, the purchased AI model becomes usable at the image sensor 30.

At Step S325 subsequent to Step S324, the image sensor 30 performs execution control of AI processing such that a use upper limit condition represented by the license data is satisfied. That is, first, the image sensor 30 enables a mode for permitting execution of AI processing performed by the AI image processing section 44. Then, in response to the start of the execution of AI processing by the AI image processing section 44, a time-measurement operation, specifically, time-measurement based on a count value of the number of processing frames of AI processing in the present example, is performed. Subsequently, it is determined whether or not the processing time of AI processing measured in such a manner has exceeded the use period represented by the use upper limit condition information in the license data. If the processing time described above has not exceeded the use period described above, the image sensor 30 allows the AI image processing section 44 to continue AI processing, and in a case where the processing time described above has exceeded the use period described above, the image sensor 30 causes the AI image processing section 44 to stop AI processing.

In response to the execution of the process at Step S325, the image sensor 30 ends the series of processing depicted in FIG. 10.

Note that, as can be understood from the explanation with reference to FIG. 9 and FIG. 10 described above, in the present example, the license data is transmitted from the server apparatus 1 to the image sensor 30 as data separate from data concerning the AI model.

Further, the license data is transmitted multiple times to the image sensor 30 in the license contract period. Specifically, in the present example, in response to a use start request made by the image sensor 30, whose power supply is interrupted multiple times in the license contract period, for example, daily and so on, every time the image sensor 30 is activated, the server apparatus 1 transmits the license data to the image sensor 30, and accordingly, the license data is transmitted multiple times in the license contract period.

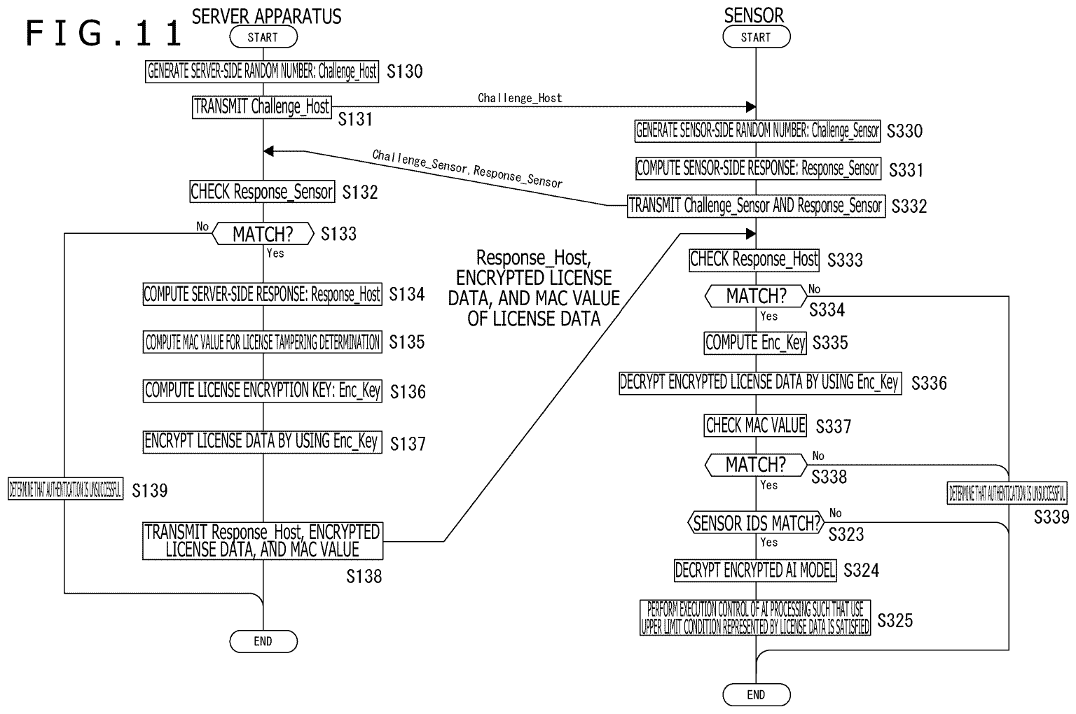

FIG. 11 is a flowchart depicting processes related to license data transmission and the challenge response authentication performed between the server apparatus 1 and the image sensor 30.

Note that, also in FIG. 11, processes depicted under “SERVER APPARATUS” are executed by the CPU 11 of the server apparatus 1 and that processes depicted under “SENSOR” are executed by the in-sensor control section 43 in the image sensor 30.

The server apparatus 1 starts processes depicted in FIG. 11 in response to the authentication start notification (S122) depicted in FIG. 10. That is, processes performed by the server apparatus and processes performed by the image sensor 30 depicted in FIG. 11 correspond to the authentication process at Step S123 and the authentication process at Step S322, respectively, depicted in FIG. 10.

First, at Step S130, the server apparatus 1 generates a server-side random number: Challenge Host. This random number: Challenge Host may be a true random number or may be a pseudo-random number.

Then, at Step S131 subsequent to Step S130, the server apparatus 1 transmits the generated Challenge Host to the image sensor 30.

In response to reception of Challenge Host transmitted at Step S131, the image sensor 30 performs a process for generating a sensor-side random number: Challenge Sensor at Step S330. This random number: Challenge Sensor may also be a true random number or may be a pseudo-random number.

Here, a memory considered to be required for generation of the pseudo-random number cannot be reserved in the image sensor 30 in the case supposed in the present example, and a true random number is generated as Challenge Sensor. Specifically, in the present example, the random number as Challenge Sensor is generated by the random number generating section 49 depicted in FIG. 3.

The random number generating section 49 generates the random number on the basis of noise generated in a captured image obtained by the image-capturing section 41. The noise generated in a captured image described here means noise as thermal noise that is generated due to heat of an electronic circuit that the image-capturing section 41 has.

There are various techniques as a technique to sense noise generated in a captured image. For example, if the image-capturing optical system 31 has a configuration having a mechanical shutter, the image-capturing section 41 is caused to execute an image-capturing operation in a state where the in-sensor control section 43 causes the image-capturing optical system 31 to close a shutter. Because a captured image obtained thereby has only noise components as thermal noise (because light is not incident on the light reception surface), the random number generating section 49 is caused to receive input of the captured image and generate the random number (true random number) on the basis of the signal values (luminance values) of respective pixels of the captured image.

Alternatively, even in a case where the image-capturing optical system 31 does not have a mechanical shutter, the least significant bit in the signal value of each pixel can be considered as being influenced by thermal noise, and accordingly, it is also possible that the random number is generated using the values of the least significant bits of respective pixels.

By using the random number generating section 49 described above, in enabling the challenge response authentication, it becomes unnecessary to provide the sensor apparatus with dedicated hardware for random number generation.

In addition, it becomes possible to perform random number generation for the challenge response authentication even in the image sensor 30 in which a memory for pseudo-random number generation is not reserved.

At Step S331 subsequent to Step S330, the image sensor 30 computes a sensor-side response: Response Sensor. Specifically, the image sensor 30 computes Response Sensor according to [Math. 1] described below on the basis of Challenge Host (Ch_H) received from the server apparatus 1, Challenge Sensor (Ch_S) obtained at Step S330, “Key_Auth” which is an authentication key shared with the server apparatus 1 in advance, and “Auth1” as Magic Word.

Response Sensor=Hash(Key_Auth∥“Auth1”∥Ch_H∥Ch_S) [Math. 1]

Note that, for example, Hash ( ) means a hash function such as SHA-256.

Here, in realizing, between the server apparatus 1 and the image sensor 30, the challenge response authentication, encryption/decryption of license data, and determination as to whether or not the license data has been tampered with, “Key_Auth” (authentication key) described above, “Auth1” described above, and each Magic Word of “Auth2 “MAC”ENC” described later are shared between the server apparatus 1 and the image sensor 30 by using the license authorization function F1 described before. In the image sensor 30, for example, information regarding “Key_Auth” and each Magic Word of “Auth1”Auth2 “MAC”ENC” is stored on a predetermined non-volatile memory in the image sensor 30 such as the non-volatile memory section 43n depicted in FIG. 3, and it is made possible for the in-sensor control section 43 to read out the information.

In response to the computation of Response Sensor at Step S331, at Step S332, the image sensor 30 transmits Challenge Host and Response Sensor to the server apparatus 1.

The server apparatus 1 having received Challenge Host and Response Sensor transmitted from the side of the image sensor 30 in the process at Step S332 described above checks Response Sensor at Step S132. That is, the server apparatus 1 computes Response Sensor according to [Math. 1] by using Challenge Host (Ch_H) generated by itself at Step S131, Challenge Sensor (Ch_S) received from the image sensor 30, and Key_Auth and “Auth1” shared with the side of the image sensor 30.

Then, at Step S133 subsequent to Step S132, as a match determination process, the server apparatus 1 determines whether or not Response Sensor computed (checked) at Step S132 and Response Sensor received from the side of the image sensor 30 match.

In a case where it is determined at Step S133 that the two types of Response Sensor do not match, the server apparatus 1 proceeds to Step S139, determines that the authentication is unsuccessful, and ends the series of processing depicted in FIG. 11. That is, in this case, transmission of license data at Step S138 described later is not performed, and accordingly, the AI model becomes unusable at the image sensor 30.

On the other hand, in a case where it is determined at Step S133 that the two types of Response Sensor match, in processes at Step S134 to S137, the server apparatus 1 performs processes for generating Response Host, license data having been encrypted (encrypted license data), and license-data-tampering determination data that should be transmitted to the side of the image sensor 30.

Specifically, at Step S134, the server apparatus 1 computes a server-side response: Response Host. That is, the server apparatus 1 computes Response Host according to [Math. 2] described below on the basis of Challenge Host (Ch_H) obtained at Step S130 described earlier, Challenge Sensor (Ch_S) received from the image sensor 30, and Key_Auth and “Auth2” as Magic Word that are shared with the image sensor 30 in advance.

Response Host=Hash(Key_Auth∥“Auth2”∥Ch_H∥Ch_S) [Math.2]

At Step S135 subsequent to Step S134, the server apparatus 1 computes a MAC (Message Authentication Code) value for license tampering determination. The MAC value is an example of license-data-tampering determination data, and specifically is computed according to [Math. 3] described below.

MAC=Hash(Key_Auth∥“MAC”∥license data∥Ch_H∥Ch_S) [Math. 3]

In [Math. 3], the license data is the license data generated at Step S121 (FIG. 10) described earlier.

At Step S136 subsequent to Step S135, the server apparatus 1 computes license encryption key: Enc_Key according to [Math. 4] described below.

Enc_Key=Hash(Key_Auth∥“ENC”∥Ch_H∥Ch_S) [Math. 4]

At Step S137 subsequent to Step S136, the server apparatus 1 encrypts the license data by using Enc_Key. That is, the server apparatus 1 encrypts the license data generated at Step S121 described earlier, by using Enc_Key.

At Step S138 subsequent to Step S137, the server apparatus 1 transmits Response Host, the encrypted license data, and the MAC value to the image sensor 30.

The image sensor 30 having received Response Host, the encrypted license data, and the MAC value transmitted at Step S137 described above checks Response Host at Step S333. That is, the image sensor 30 computes Response Host according to [Math. 2] described earlier, by using Challenge Host (Ch_H) received from the server apparatus 1, Challenge Sensor (Ch_S) obtained at Step S130 described earlier, and Key_Auth and “Auth2” that are shared with the server apparatus 1.

At Step S334 subsequent to Step S333, as a match determination process, the image sensor 30 determines whether or not Response Host computed (checked) at Step S333 and Response Host received from the side of the server apparatus 1 match.

In a case where it is determined at Step S334 that the two types of Response Host do not match, the image sensor 30 proceeds to Step S339, determines that the authentication is unsuccessful, and ends the series of processing depicted in FIG. 11. That is, in this case, the encrypted-AI-model decryption at Step S324 is not performed, and accordingly, the AI model becomes unusable at the image sensor 30.

On the other hand, in a case where it is determined at Step S334 that the two types of Response Host match, the image sensor 30 proceeds to Step S335, and computes Enc_Key. That is, the image sensor 30 computes Enc_Key according to [Math. 4] described earlier, on the basis of Challenge Sensor (Ch_S) obtained at Step S130, Challenge Host (Ch_H) received from the server apparatus 1, and Key_Auth and “ENC” shared with the server apparatus 1.

Then, at Step S336 subsequent to Step S335, the image sensor 30 decrypts the encrypted license data by using Enc_Key.

At Step S337 subsequent to Step S336, the image sensor 30 checks the MAC value. That is, the image sensor 30 computes a MAC value according to [Math. 3] described earlier, on the basis of Challenge Sensor (Ch_S) obtained at Step S130, Challenge Host (Ch_H) received from the server apparatus 1, Key_Auth and “MAC” shared with the server apparatus 1, and the license data decrypted at Step S336.

Then, at Step S338 subsequent to Step S337, as a match determination process, the image sensor 30 determines whether or not the MAC value received from the server apparatus 1 and the MAC value computed (checked) at Step S337 match. That is, this is determination as to whether or not the license data has been tampered with.

In a case where it is determined at Step S338 that the two MAC values do not match, the image sensor 30 determines at Step S339 that the authentication is unsuccessful, and ends the series of processing depicted in FIG. 11 . . . . That is, in a case where it is determined, in the determination as to whether or not the license data has been tampered with, that the license data has been tampered with, the AI model becomes unusable at the image sensor 30.

On the other hand, in a case where it is determined at Step S338 that the two MAC values match, the image sensor 30 performs the process at Step S323 explained earlier, that is, performs the process of determining whether or not the sensor ID in the license data and the sensor ID of itself match.

As has been explained earlier, in a case where the two sensor IDs do not match, the process at Step S324 is not performed, and the AI model becomes unusable at the image sensor 30.

On the other hand, in a case where the two sensor IDs match, the encrypted AI model is decrypted in the process at Step S324 explained earlier, and then, the process at Step S325 is executed. That is, execution control of AI processing by the AI image processing section 44 is performed such that a use upper limit condition included in the license data is satisfied.

Note that, whereas, in the description above, the entire license data is encrypted on the basis of the authentication key (Key_Auth) and the challenge response authentication is performed, instead of this, it is also possible that only the AI model encryption key in the license data is encrypted on the basis of the authentication key (Key_Auth) and the challenge response authentication is performed.

### 4. Modification Examples

Note that embodiments are not limited to the specific examples described above and can adopt diverse configurations as modification examples.

For example, whereas, in examples in the description above, a use start request is made to the server apparatus 1 every time an image sensor 30 is activated, these are merely examples. It is also possible that a use start request is made when another predetermined condition not related to activation is satisfied.

For example, in a case where it is supposed that an image sensor 30 is activated continuously for 24 hours, for example, it is possible that the image sensor 30 makes a use start request to the server apparatus 1 at predetermined time intervals such as at timings when the date changes or the like, for example.

In addition, it is not essential for an image sensor 30 to make a use start request to the server apparatus 1. For example, in a case where it is supposed that an image sensor 30 is activated continuously for 24 hours, for example, it is possible that the server apparatus 1 transmits license data to the image sensor 30 at predetermined time intervals such as at timings when the date changes or the like.

In addition, whereas the process of authenticating license data is performed by the challenge response authentication in the description above, the authentication of license data is not limited to the challenge response authentication. For example, it is possible that the authentication uses a master key stored in advance on an image sensor 30. The master key described here means key information stored on the image sensor 30 as a compatible product before the start of use of the apparatus, such as at the time of manufacture. For example, it is possible that the master key is stored on a predetermined non-volatile memory in the image sensor 30, such as the non-volatile memory section 43n in the in-sensor control section 43.

Note that a common value for each model number of image sensors 30 is supposed to be allocated as a master key. Alternatively, as another example, it is also possible that a common value for each manufacture lot, a common value for each firmware version, or the like is allocated.

In this case, license data is encrypted using an encryption key based on a master key described above, and transmitted from the server apparatus 1 to an image sensor 30. The image sensor 30 having received the license data decrypts the license data by using a key generated on the basis of the master key stored on itself.

Here, in a case where a master key is used as an encryption key of license data as described above, the encryption key of the license data does not become a volatile key (a key which is valid only once) unlike in a case where the challenge response authentication is performed. Because of this, in a case where eavesdropping of a communication path has been successful undesirably (i.e., in a case where a key has been identified), it becomes undesirably possible to decrypt license data by sending the same license data to the side of the image sensor 30. Stated differently, in a case illustrated in the description above where the technique in which license data for which a use upper limit such as 24 hours is specified is transmitted again and again in response to requests is adopted, it becomes undesirably possible to permanently keep using an AI model by keeping sending the license data for which eavesdropping has been successful to the side of the image sensor 30.

Because of this, in a case where license data is encrypted using a master key, it is required to specify an absolute deadline, that is, specify at least the end date and time of a usable period, as a use upper limit condition.

Accordingly, in a case where the technique in which license data is encrypted using a master key is adopted, a real time clock is provided to an image sensor 30, and the in-sensor control section 43 performs execution control of AI processing on the basis of time measurement information of the real time clock and use upper limit condition information that specifies an absolute deadline as described above. Alternatively, it is also possible that a real time clock is provided outside an image sensor 30, for example, to the control section 33, and, in this case, the in-sensor control section 43 performs execution control of AI processing according to use upper limit condition information on the basis of time measurement information of the real time clock provided outside the image sensor 30 as described above.

Here, whereas cameras 3 are configured to obtain color images as captured images in cases illustrated in the explanation given thus far, “capturing images” in the present specification broadly means obtaining image data capturing images of subjects. Image data described here collectively refers to data including multiple pieces of pixel data, and the concept of pixel data broadly covers not only data representing the intensity of reception-light amounts from subjects, but also, for example, the distances to subjects, polarization information, temperature information, and the like. That is, “image data” obtained by “image-capturing” includes data as greyscale images representing information regarding the intensity of a reception-light amount for each pixel, data as distance images representing information regarding the distance to a subject for each pixel, data as polarization images representing polarization information regarding incident light for each pixel, data as thermal images representing temperature information for each pixel, and the like.

In addition, whereas, in the explanation given thus far, a period-wise condition is illustrated as a use upper limit condition represented by license data, a use upper limit condition in the present technology broadly means a condition related to a use upper limit of an AI model.

For example, examples of a use upper limit condition not related to a period include a condition related to the processing amount of AI processing. For example, examples of a use upper limit condition in license data transmitted multiple times in a license contract period daily and so on include specifying an upper limit value of the number of sensed objects regarding an AI model that performs an object sensing process, and so on. In this case, in response to reception of license data, an image sensor 30 (in-sensor control section 43) performs execution control of AI processing performed by the AI image processing section 44, such that the number of objects sensed by the AI image processing section 44 does not exceed the upper limit value of the number of sensed objects represented by use upper limit condition information in the license data.

In addition, whereas, in the explanation given thus far, license data is illustrated as an example of data to be treated in authentication processes such as the challenge response authentication, data to be treated in authentication processes is not limited these, and it is also possible that, for example, image quality adjustment parameters of image sensors 30 are treated. Image quality adjustment parameters described here broadly mean shutter speeds, gains, and other parameters related to image quality adjustment. In addition, information regarding image quality adjustment parameters may include flag information representing instructions regarding whether parameter settings are set manually or automatically.

For example, by encrypting image quality adjustment parameters, transferring the encrypted image quality adjustment parameters, and determining, by using MAC values, whether or not the quality adjustment parameters have been tampered with, the confidentiality/completeness of information regarding the image quality adjustment parameters can also be ensured as with the case of license data.

### 5. Summary of Embodiment

As explained above, a sensor apparatus (image sensor 30) as an embodiment includes an image-capturing section (image-capturing section 41) that captures an image of a subject, an AI processing section (AI image processing section 44) that performs AI processing which is a process using an AI model on an image captured by the image-capturing section, and a control section (in-sensor control section 43) that receives, from an external apparatus, license data representing a use upper limit condition related to the AI model and performs execution control of the AI processing performed by the AI processing section, such that the use upper limit condition is satisfied.

According to the configuration described above, the AI processing section is provided in the sensor apparatus having the image-capturing section. Further, according to the configuration described above, in a case where the AI model is to be used in a subscription-service-like manner for an image-capturing apparatus having an AI function, for example, the execution control of AI processing for satisfying the use upper limit condition such as a use deadline is performed in the sensor apparatus. Since the execution control of AI processing for satisfying the use upper limit condition is performed in the sensor apparatus in such a manner, it becomes possible to make it difficult for the use upper limit condition to be operated fraudulently, even if there is an attack on a communication path between the sensor apparatus and a processor outside the sensor apparatus in the image-capturing apparatus.

Accordingly, when the AI model is to be used in a subscription-service-like manner for the image-capturing apparatus having the AI function, it is possible to attempt to prevent use of the AI model deviating from the use upper limit condition from being performed undesirably by a fraudulent act or the like. That is, it is possible to attempt to prevent the AI model from being fraudulently used undesirably.

In addition, in the sensor apparatus as an embodiment, the AI processing section is configured to be capable of changing an AI model to be used, the control section performs a process of setting an AI model received from an external apparatus, as an AI model to be used by the AI processing section, and the license data is data transmitted from an external apparatus as data separate from the AI model.

Accordingly, in a case where the AI model is to be used in a subscription-service-like manner, it becomes possible to transmit the license data to the sensor apparatus at a timing different from transmission timing of the AI model. For example, it becomes possible to transmit the AI model at a timing when a contract has been concluded by the payment of a price or the like and transmit the license data at a timing when the sensor apparatus actually starts using the AI model.

Accordingly, it is possible to attempt to prevent the processing load of the external apparatus or the sensor apparatus from increasing undesirably due to an increase of the amount of data transmitted and received by the external apparatus or the sensor apparatus at use start time of the AI model.

In addition, in particular, in a case where a configuration in which the license data is volatile data and is transmitted multiple times to the sensor apparatus in a license contract period is adopted, it becomes unnecessary to transmit the AI model along with the license data. For example, since the AI model has a relatively large data volume such as several megabytes, removing the necessity of transmitting the AI model multiple times can reduce the processing load of the AI-model transmitting side. In particular, in a case where the AI-model transmitting side manages, for multiple sensor apparatuses, transmission of AI models, it is possible to significantly reduce the amount of data that should be transmitted and also significantly reduce the processing load. Further, in a case where the AI model is transmitted after being encrypted as a security measure as in the embodiment, it also becomes unnecessary to perform an encryption process on the AI model multiple times in the license contract period, and accordingly, it is possible to attempt to further reduce the processing load.

Further, in the sensor apparatus as an embodiment, the external apparatus encrypts the AI model, transmits the encrypted AI model to the sensor apparatus, and transmits, as the license data, data including an encryption key of the AI model, and the control section decrypts the AI model on the basis of the encryption key included in the license data.

Accordingly, it becomes possible to make the AI model unusable unless the AI model is received.

Accordingly, it is possible to attempt to prevent the AI model from becoming fraudulently usable undesirably without reception of the license data, and it is possible to attempt to enhance security.

Still further, in the sensor apparatus as an embodiment, the control section performs, with the external apparatus, a process of challenge response authentication as an authentication process regarding the license data.

Accordingly, it becomes possible to enhance tolerance against fraudulent access as a replay attack, and it becomes possible to enhance an advantage of preventing occurrence of a fraudulent act such as tampering of the license data.

Accordingly, it is possible to attempt to prevent undesirable use of the AI model deviating from the use upper limit condition.

In addition, in the sensor apparatus as an embodiment, the license data is transmitted multiple times in a license contract period of the AI model, and the control section performs the execution control on the basis of the received license data every time the license data is received.

Since the challenge response authentication is adopted for the authentication process regarding the license data, the encryption key of the license data becomes a key which is valid only for one session. Stated differently, the license data is a volatile license which is valid only for one session. By making the license data a volatile license in such a manner, it becomes possible to transmit, as the license data to the sensor apparatus, data for which a condition corresponding to a use upper limit period shorter than the license contract period is specified as the use upper limit condition, multiple times in the license contract period as in the configuration described above.

If a technique in which one piece of license data representing a usable period of a one-month period is transmitted to a sensor apparatus only once for a license of a one-month period is adopted, in a case where eavesdropping of the license data is successful undesirably, use deviating from a license condition according to a contract becomes possible undesirably. In contrast to this, by adopting the technique in which volatile license data is transmitted separately multiple times in a license period according to a contract as described above, even if eavesdropping of a piece of license data is successful, security of another piece of license data transmitted at another timing can be ensured, and it is possible to attempt to prevent undesirable fraudulent use of an AI model deviating from a contract condition.

In addition, in the sensor apparatus as an embodiment, the control section performs the execution control on the basis of the license data and a count value of the number of processing frames of the AI processing section.

According to the configuration described above, management of the use upper limit condition according to the license data can be performed on the basis of the count value of the number of processing frames of the AI processing section, and accordingly, it becomes unnecessary to provide a real time clock to the sensor apparatus for management of the use upper limit condition.

Accordingly, it becomes unnecessary to keep supplying power to the sensor apparatus for driving a real time clock, and it is possible to attempt to reduce power consumption.

Further, the sensor apparatus as an embodiment includes a random number generating section (random number generating section 49) that generates a random number to be used for the challenge response authentication, on the basis of noise generated in the captured image.

Accordingly, in enabling the challenge response authentication, it becomes unnecessary to provide the sensor apparatus with dedicated hardware for random number generation.

Accordingly, it is possible to attempt to reduce the number of constituent parts of the sensor apparatus and reduce costs.

In addition, it becomes possible to perform random number generation for the challenge response authentication even in a sensor apparatus in which a memory for pseudo-random number generation is not reserved.

Still further, in the sensor apparatus as an embodiment, the license data includes information representing the use upper limit condition and a sensor ID for identifying a sensor apparatus, and the control section performs the execution control on the basis of a result of collation between the sensor ID included in the license data and a sensor ID of the sensor apparatus.

Accordingly, it becomes possible for the sensor apparatus to perform control such that AI processing is performed only in a case where the sensor ID of the sensor apparatus matches the sensor ID included in the license data.

Accordingly, it is possible to attempt to make only a contract-target sensor apparatus able to use the AI model, and it is possible to attempt to prevent undesirable fraudulent use of the AI model by a non-contract-target sensor apparatus.

In addition, in the sensor apparatus as an embodiment, key information (authentication key: Key_Auth) is stored on a predetermined memory in the sensor apparatus, the license data is encrypted on the basis of key information identical to the key information and transmitted to the sensor apparatus, and the control section receives encrypted license data which is the license data having been encrypted, decrypts the encrypted license data on the basis of the key information stored on the memory, and uses the encrypted license data for the execution control.

Accordingly, it becomes possible to make only the sensor apparatus as a compatible product on which key information has been stored in advance able to decrypt the license data.

Accordingly, it is possible to attempt to prevent a sensor apparatus as an incompatible product on which key information is not stored from undesirably receiving the license data and becoming able to use the AI model.

Further, in the sensor apparatus as an embodiment, the external apparatus transmits the license data and tampering determination data which is data for determining whether or not the license data has been tampered with, and the control section performs the execution control based on the license data, provided that it is determined on the basis of the tampering determination data that the license data has not been tampered with.

Accordingly, it becomes possible to attempt to prevent undesirable use of the AI model on the basis of data other than the correct license data.

Accordingly, it is possible to attempt to prevent fraudulent use of the AI model.

In addition, a control method as an embodiment is a control method to be performed in a sensor apparatus including an image-capturing section that captures an image of a subject and an AI processing section that performs AI processing which is a process using an AI model on an image captured by the image-capturing section, the control method including receiving, from an external apparatus, license data representing a use upper limit condition related to the AI model and performing execution control of the AI processing performed by the AI processing section, such that the use upper limit condition is satisfied.

Also with such a control method, effects and advantages similar to those achieved with the sensor apparatus as an embodiment described above can be achieved.

An information processing apparatus (server apparatus 1) as an embodiment includes a transmitting section (communicating section 20) that transmits license data representing a use upper limit condition related to an AI model to a sensor apparatus (image sensor 30) including an image-capturing section that captures an image of a subject, an AI processing section that performs AI processing which is a process using the AI model on an image captured by the image-capturing section, and a control section that performs, on the basis of the license data, execution control of the AI processing performed by the AI processing section, such that the use upper limit condition is satisfied.

With such an information processing apparatus, the AI model use condition for the sensor apparatus can be specified.

In addition, an information processing system (100) as an embodiment includes a sensor apparatus (image sensor 30) having an image-capturing section that captures an image of a subject, an AI processing section that performs AI processing which is a process using an AI model on an image captured by the image-capturing section, and a control section that performs, on the basis of license data representing a use upper limit condition related to the AI model, execution control of the AI processing performed by the AI processing section, such that the use upper limit condition is satisfied, and an information processing apparatus (server apparatus 1) having a transmitting section that transmits the license data to the sensor apparatus.

With such an information processing system, it is possible to attempt to prevent the AI model from being fraudulently used undesirably in an image-capturing apparatus having an AI function.

Note that advantages described in the present specification are merely illustrated as examples and are not the sole examples, and there may be other advantages.

### 6. Present Technology

The present technology can also adopt configurations depicted below.

(1)

A sensor apparatus including:
an image-capturing section that captures an image of a subject;
an AI processing section that performs AI processing which is a process using an AI model on an image captured by the image-capturing section; and
a control section that receives, from an external apparatus, license data representing a use upper limit condition related to the AI model and performs execution control of the AI processing performed by the AI processing section, such that the use upper limit condition is satisfied.
   (2)

The sensor apparatus according to (1) above, in which
the AI processing section is configured to be capable of changing an AI model to be used,
the control section performs a process of setting an AI model received from an external apparatus, as an AI model to be used by the AI processing section, and
the license data is data transmitted from an external apparatus as data separate from the AI model.
   (3)

The sensor apparatus according to (1) or (2) above, in which
the external apparatus encrypts the AI model, transmits the encrypted AI model to the sensor apparatus, and transmits, as the license data, data including an encryption key of the AI model, and
the control section decrypts the AI model on the basis of the encryption key included in the license data.
   (4)

The sensor apparatus according to any one of (1) to (3) above, in which
the control section performs, with the external apparatus, a process of challenge response authentication as an authentication process regarding the license data.
   (5)

The sensor apparatus according to (4) above, in which
the license data is transmitted multiple times in a license contract period of the AI model, and
the control section performs the execution control on the basis of the received license data every time the license data is received.
   (6)

The sensor apparatus according to (5) above, in which
the control section performs the execution control on the basis of the license data and a count value of the number of processing frames of the AI processing section.
   (7)

The sensor apparatus according to any one of (4) to (6) above, including:
a random number generating section that generates a random number to be used for the challenge response authentication, on the basis of noise generated in the captured image.
   (8)

The sensor apparatus according to any one of (1) to (7) above, in which
the license data includes information representing the use upper limit condition and a sensor ID for identifying a sensor apparatus, and
the control section performs the execution control on the basis of a result of collation between the sensor ID included in the license data and a sensor ID of the sensor apparatus.
   (9)

The sensor apparatus according to any one of (1) to (8) above, in which
key information is stored on a predetermined memory in the sensor apparatus,
the license data is encrypted on the basis of key information identical to the key information and transmitted to the sensor apparatus, and
the control section receives encrypted license data which is the license data having been encrypted, decrypts the encrypted license data on the basis of the key information stored on the memory, and uses the encrypted license data for the execution control.
   (10)

The sensor apparatus according to any one of (1) to (9) above, in which
the external apparatus transmits the license data and tampering determination data which is data for determining whether or not the license data has been tampered with, and
the control section performs the execution control based on the license data, provided that it is determined on the basis of the tampering determination data that the license data has not been tampered with.
   (11)

A control method to be performed in a sensor apparatus including an image-capturing section that captures an image of a subject and an AI processing section that performs AI processing which is a process using an AI model on an image captured by the image-capturing section, the control method including:
receiving, from an external apparatus, license data representing a use upper limit condition related to the AI model and performing execution control of the AI processing performed by the AI processing section, such that the use upper limit condition is satisfied.
   (12)

An information processing apparatus including:
a transmitting section that transmits license data representing a use upper limit condition related to an AI model to a sensor apparatus including an image-capturing section that captures an image of a subject, an AI processing section that performs AI processing which is a process using the AI model on an image captured by the image-capturing section, and a control section that performs, on the basis of the license data, execution control of the AI processing performed by the AI processing section, such that the use upper limit condition is satisfied.
   (13)

An information processing system including:
a sensor apparatus having
   an image-capturing section that captures an image of a subject,
   an AI processing section that performs AI processing which is a process using an AI model on an image captured by the image-capturing section, and
   a control section that performs, on the basis of license data representing a use upper limit condition related to the AI model, execution control of the AI processing performed by the AI processing section, such that the use upper limit condition is satisfied; and
an information processing apparatus having a transmitting section that transmits the license data to the sensor apparatus.

### REFERENCE SIGNS LIST

1: Server apparatus
3: Camera
F1: License authorization function
F2: Account service function
F3: Marketplace function
F4: AI service function
30: Image sensor
31: Image-capturing optical system
32: Optical system drive section
33: Control section
34: Memory section
35: Communicating section
36: Sensor section
37: Bus
41: Image-capturing section
42: Image signal processing section
43: In-sensor control section
43n: Non-volatile memory section
43v: Volatile memory section
43a: Authentication processing section
43b: Execution control section
44: AI image processing section
45: Memory section
46: Computer vision processing section
47: Communication interface
48: Bus
49: Random number generating section

1. A sensor apparatus comprising:
an image-capturing section that captures an image of a subject;
an AI processing section that performs AI processing which is a process using an AI model on an image captured by the image-capturing section; and
a control section that receives, from an external apparatus, license data representing a use upper limit condition related to the AI model and performs execution control of the AI processing performed by the AI processing section, such that the use upper limit condition is satisfied.

2. The sensor apparatus according to claim 1, wherein
the AI processing section is configured to be capable of changing an AI model to be used,
the control section performs a process of setting an AI model received from an external apparatus, as an AI model to be used by the AI processing section, and
the license data is data transmitted from an external apparatus as data separate from the AI model.

3. The sensor apparatus according to claim 1, wherein
the external apparatus encrypts the AI model, transmits the encrypted AI model to the sensor apparatus, and transmits, as the license data, data including an encryption key of the AI model, and
the control section decrypts the AI model on a basis of the encryption key included in the license data.

4. The sensor apparatus according to claim 1, wherein
the control section performs, with the external apparatus, a process of challenge response authentication as an authentication process regarding the license data.

5. The sensor apparatus according to claim 4, wherein
the license data is transmitted multiple times in a license contract period of the AI model, and
the control section performs the execution control on a basis of the received license data every time the license data is received.

6. The sensor apparatus according to claim 5, wherein
the control section performs the execution control on a basis of the license data and a count value of the number of processing frames of the AI processing section.

7. The sensor apparatus according to claim 4, comprising:
a random number generating section that generates a random number to be used for the challenge response authentication, on a basis of noise generated in the captured image.

8. The sensor apparatus according to claim 1, wherein
the license data includes information representing the use upper limit condition and a sensor ID for identifying a sensor apparatus, and
the control section performs the execution control on a basis of a result of collation between the sensor ID included in the license data and a sensor ID of the sensor apparatus.

9. The sensor apparatus according to claim 1, wherein
key information is stored on a predetermined memory in the sensor apparatus,
the license data is encrypted on a basis of key information identical to the key information and transmitted to the sensor apparatus, and
the control section receives encrypted license data which is the license data having been encrypted, decrypts the encrypted license data on a basis of the key information stored on the memory, and uses the encrypted license data for the execution control.

10. The sensor apparatus according to claim 1, wherein
the external apparatus transmits the license data and tampering determination data which is data for determining whether or not the license data has been tampered with, and
the control section performs the execution control based on the license data, provided that it is determined on a basis of the tampering determination data that the license data has not been tampered with.

11. A control method to be performed in a sensor apparatus including an image-capturing section that captures an image of a subject and an AI processing section that performs AI processing which is a process using an AI model on an image captured by the image-capturing section, the control method comprising:
receiving, from an external apparatus, license data representing a use upper limit condition related to the AI model and performing execution control of the AI processing performed by the AI processing section, such that the use upper limit condition is satisfied.

12. An information processing apparatus comprising:
a transmitting section that transmits license data representing a use upper limit condition related to an AI model to a sensor apparatus including an image-capturing section that captures an image of a subject, an AI processing section that performs AI processing which is a process using the AI model on an image captured by the image-capturing section, and a control section that performs, on a basis of the license data, execution control of the AI processing performed by the AI processing section, such that the use upper limit condition is satisfied.

13. An information processing system comprising:
a sensor apparatus having
an image-capturing section that captures an image of a subject,
an AI processing section that performs AI processing which is a process using an AI model on an image captured by the image-capturing section, and
a control section that performs, on a basis of license data representing a use upper limit condition related to the AI model, execution control of the AI processing performed by the AI processing section, such that the use upper limit condition is satisfied; and
an information processing apparatus having a transmitting section that transmits the license data to the sensor apparatus.
